(19) United States
(12) Patent Application Publication
(10) Pub. No.: US 2023/0315655 A1
(43) Pub. Date: Oct. 5, 2023

(54) FAST DATA SYNCHRONIZATION IN PROCESSORS AND MEMORY

(71) Applicant: NVIDIA Corporation, Santa Clara, CA (US)

(72) Inventors: Jack CHOQUETTE, Santa Clara, CA (US); Ronny KRASHINSKY, Santa Clara, CA (US); Timothy GUO, Santa Clara, CA (US); Carter EDWARDS, Santa Clara, CA (US); Steve HEINRICH, Santa Clara, CA (US); John EDMONDSON, Santa Clara, CA (US); Prakash Bangalore PRABHAKAR, Santa Clara, CA (US); Apoorv PARLE, JR., Santa Clara, CA (US); Manan PATEL, Santa Clara, CA (US); Olivier GIROUX, Santa Clara, CA (US); Michael PELLAUER, Santa Clara, CA (US)

(21) Appl. No.: 17/691,303

(22) Filed: Mar. 10, 2022

(51) Int. Cl. G06F 13/16

(52) U.S. Cl. CPC G06F 13/1689; G06F 13/1673

(57) ABSTRACT

A new synchronization system synchronizes data exchanges between producer processes and consumer processes which may be on the same or different processors in a multiprocessor system. The synchronization incurs less than one roundtrip of latency - in some implementations, in approximately 0.5 roundtrip times. A key aspect of the fast synchronization is that the producer’s data store is followed without delay with the updating of a barrier on which the consumer is waiting.

### CROSS-REFERENCES TO RELATED APPLICATIONS

This application is related to the following commonly-assigned copending US patent applications, the entire contents of each of which are incorporated by reference:
U.S. Application No. 17/691,276 filed Mar. 10, 2022, titled “Method And Apparatus For Efficient Access To Multidimensional Data Structures And/Or Other Large Data Blocks”;
U.S. Application No. 17/691,621 filed Mar. 10, 2022, titled “Cooperative Group Arrays”;
U.S. Application No. 17/691,690 filed Mar. 10, 2022, titled “Distributed Shared Memory”;
U.S. Application No. 17/691,759 filed Mar. 10, 2022, titled “Virtualizing Hardware Processing Resources in a Processor”;
U.S. Application No. 17/691,288 filed Mar. 10, 2022, titled “Programmatically Controlled Data Multicasting Across Multiple Compute Engines”;
U.S. Application No. 17/691,296 filed Mar. 10, 2022, titled “Hardware Accelerated Synchronization With Asynchronous Transaction Support”;
U.S. Application No. 17/691,406 filed Mar. 10, 2022, titled “Efficient Matrix Multiply and Add with a Group of Warps”;
U.S. Application No. 17/691,872 filed Mar. 10, 2022, titled “Techniques for Scalable Load Balancing of Thread Groups in a Processor”;
U.S. Application No. 17/691,808 filed Mar. 10, 2022, titled “Flexible Migration of Executing Software Between Processing Components Without Need For Hardware Reset”; and
U.S. Application No. 17/691,422 filed Mar. 10, 2022, titled “Method And Apparatus For Efficient Access To Multidimensional Data Structures And/Or Other Large Data Blocks”.

### FIELD

This technology generally relates to improving processing efficiency. More particularly, the technology herein relates to specialized circuitry for handling data synchronization.

### BACKGROUND

Users want deep learning and high performance computing (HPC) compute programs to continue to scale as graphics processing unit (GPU) technology improves and the number of processing core units increases per chip with each generation. What is desired is a faster time to solution for a single application, not scaling only by running N independent applications.

FIG. 1A shows example deep learning (DL) networks comprising long chains of sequentially-dependent compute-intensive layers. Each layer is calculated using operations such as e.g., multiplying input activations against a matrix of weights to produce output activations. The layers are typically parallelized across a GPU or cluster of GPUs by dividing the work into output activation tiles each representing the work one processing core will process.

Due to the potentially massive number of computations deep learning requires, faster is usually the goal. And it makes intuitive sense that performing many computations in parallel will speed up processing as compared to performing all those computations serially. In fact, the amount of performance benefit an application will realize by running on a given GPU implementation typically depends entirely on the extent to which it can be parallelized. But there are different approaches to parallelism.

Conceptually, to speed up a process, one might have each parallel processor perform more work (see FIG. 1B) or one might instead keep the amount of work on each parallel processor constant and add more processors (see FIG. 1C). Consider an effort to repave a highway several miles long. You as the project manager want the repaving job done in the shortest amount of time in order to minimize traffic disruption. It is obvious that the road repaving project will complete more quickly if you have several crews working in parallel on different parts of the road. But which approach will get the job done more quickly - asking each road crew to do more work, or adding more crews each doing the same amount of work? It turns out that the answer depends on the nature of the work and the resources used to support the work.

Computer scientists refer to the first approach as “weak scaling” and the second approach as “strong scaling.”

Users of such applications thus typically want strong scaling, which means a single application can achieve higher performance without having to change its workload -- for instance, by increasing its batch size to create more inherent parallelism. Users also expect increased speed performance when running existing (e.g., recompiled) applications on new, more capable GPU platforms offering more parallel processors. GPU development has met or even exceeded the expectations of the marketplace in terms of more parallel processors and more coordination/cooperation between increased numbers of parallel execution threads running on those parallel processors - but further performance improvements to achieve strong scaling are still needed.

Parallel processing also creates the need for communication and coordination between parallel execution threads or blocks. Synchronization primitives are an essential building block to parallel programming. Besides the functionality correctness such a synchronization primitives guarantees, they also contribute to improved performance and scalability.

One way for different execution processes to coordinate their states with one another is by using barrier synchronization. Barrier synchronization typically involves each process in a collection of parallel-executing processes waiting at a barrier until all other processes in the collection catch up. No process can proceed beyond the barrier until all processes reach the barrier.

In modern GPU architectures, many execution threads execute concurrently, and many warps each comprising many threads also execute concurrently. When threads in a warp need to perform more complicated communications or collective operations, the developer can use for example NVIDIA’s CUDA “_syncwarp” primitive to synchronize threads. The _syncwarp primitive initializes hardware mechanisms that cause an executing thread to wait before resuming execution until all threads specified in a mask have called the primitive with the same mask. For more details see for example U.S. Pat. Nos. 8,381,203; 9,158,595; 9,442,755; 9,448,803; 10,002,031; and 10,013,290; and see also https://devblogs.nvidia.com/using-cuda-warp-level-primitives/; and https://docs.nvidia.com/cuda/cuda-c-programming-guide/index.html#memory-fence-functions.

Before NVIDIA’s Cooperative Groups API, both execution control (i.e., thread synchronization) and inter-thread communication were generally limited to the level of a thread block (also called a “cooperative thread array” or “CTA”) executing on one SM. The Cooperative Groups API extended the CUDA programming model to describe synchronization patterns both within and across a grid or across multiple grids and thus potentially (depending on hardware platform) spanning across devices or multiple devices. The Cooperative Groups API provides CUDA device code APIs for defining, partitioning, and synchronizing groups of threads - where “groups” are programmable and can extend across thread blocks. The Cooperative Groups API also provides host-side APIs to launch grids whose threads are all scheduled by software-based scheduling to be launched concurrently. These Cooperative Groups API primitives enable additional patterns of cooperative parallelism within CUDA, including producer-consumer parallelism and global synchronization across an entire thread grid or even across multiple GPUs, without requiring hardware changes to the underlying GPU platforms.

For example, the Cooperative Groups API provides a grid-wide (and thus often device-wide) synchronization barrier (“grid.sync()”) that can be used to prevent threads within the grid group from proceeding beyond the barrier until all threads in the defined grid group have reached that barrier. Such device-wide synchronization is based on the concept of a grid group (“grid_group”) defining a set of threads within the same grid, scheduled by software to be resident on the device and schedulable on that device in such a way that each thread in the grid group can make forward progress. Thread groups could range in size from a few threads (smaller than a warp) to a whole thread block, to all thread blocks in a grid launch, to grids spanning multiple GPUs. Newer GPU platforms such as NVIDIA Pascal and Volta GPUs enable grid-wide and multi-GPU synchronizing groups, and Volta’s independent thread scheduling enables significantly more flexible selection and partitioning of thread groups at arbitrary cross-warp and sub-warp granularities.

There is still a need for faster synchronization that can improve the performance of a group of processes executing on multiple processors.

### BRIEF DESCRIPTION OF THE DRAWINGS

FIG. 1A shows an example application running on a GPU.

FIG. 1B shows a weak scaling deep learning scenario.

FIG. 1C shows a strong scaling deep learning scenario.

FIG. 2 is a block architectural diagram of a GPU architecture including streaming multiprocessors and associated interconnects partitioned in to different µGPC partitions.

FIGS. 3A-3D are block diagrams showing example communication paths among streaming multiprocessors and memory in a GPU architecture such as that shown in FIG. 2.

FIG. 4 is a conceptual illustration of a grid of Cooperative Group Arrays (CGAs), each comprising a plurality of thread blocks referred to as cooperative thread arrays (CTAs).

FIG. 5A shows synchronized data exchange latency between two streaming multiprocessors (SM) through layer 2 memory (L2 cache) in accordance with a conventional synchronization scheme.

FIG. 5B shows an example data exchange sequence with synchronized data latency (remote) CGA memory best case according to a synchronization scheme.

FIG. 5C shows another representation of the scheme shown in FIG. 5B.

FIG. 6A illustrates a producer process issuing a combined store and arrive operation, according to some example embodiments.

FIG. 6B illustrates the use of split producer barriers that are local to the producer process, and split consumer barriers that are local to the consumer process, according to some example embodiments.

FIG. 6C illustrates an example of the synchronization according an example embodiment.

FIG. 6D shows another example message flow according to example embodiments, and illustrates how the data exchange synchronization is achieved with approximately 0.5 roundtrip times latency.

FIG. 7A shows an arrive operation on a barrier updating a transaction count of the barrier with an expected transaction count, and each store operation incrementing the transaction count, according to some example embodiments.

FIG. 7B shows an example barrier structure, according to some embodiments.

FIG. 7C shows an example instruction format for the combined store and arrive instruction, according to some example embodiments.

FIG. 7D illustrates an example non-limiting manner in which the instruction format of FIG. 7C can be implemented in a fixed-size packet structure of a processor environment, according to some example embodiments.

FIG. 8 is a schematic block diagram of a hardware-implemented barrier support unit 800 in accordance with some example embodiments.

FIG. 9A shows a conceptual view of four separate fence messages for the same barrier being replicated on multiple paths in an interconnect between two SMs, according to some example embodiments.

FIG. 9B shows configuration of a interconnect to carry L2 traffic, according to some example embodiments.

FIG. 9C shows another example barrier structure, according to some embodiments.

FIGS. 9D-9F illustrate three different data exchange models. FIG. 9D illustrates a conventional global memory based data exchange, with synchronization latency of 3 to 4 roundtrips. FIG. 9E illustrates a shared memory based SM2SM data exchange, with synchronization latency around 0.5 round-trip, according to some embodiments. FIG. 9F shows a layer 2-mediated SM2SM data exchange model in with synchronization latency is around two roundtrips.

FIG. 9G shows SOL latency for L2-mediated SM2SM data exchange, according to some example embodiments.

FIG. 9H shows a flowchart of SOL latency for L2-mediated SM-to-SM communication in a compute queue model implementation, according to some example embodiments.

FIG. 9I shows an example implementation for the operations in FIG. 9H, according to some example embodiments.

FIG. 10 illustrates an example parallel processing unit of a GPU, according to some embodiments.

FIG. 11A illustrates an example general processing cluster (GPC) within the parallel processing unit of FIG. 10 with each streaming multiprocessor in the general processing cluster being coupled to a tensor memory access unit, according to some embodiments.

FIG. 11B illustrates an example memory partition unit of the parallel processing unit of FIG. 10.

FIG. 12 illustrates an example streaming multiprocessor of FIG. 11A.

FIG. 13A is an example conceptual diagram of a processing system implemented using the parallel processing unit (PPU) of FIG. 10.

FIG. 13B is a block diagram of an exemplary system in which the various architecture and/or functionality of the various previous embodiments may be implemented.

### DETAILED DESCRIPTION OF EXAMPLE NON-LIMITING EMBODIMENTS

Embodiments of this disclosure are directed to a new synchronization primitive, methods and systems. Example embodiments provide for producer processes and consumer processes, even if executing on respectively different processors, to synchronize with low latency, such as, for example, a latency of approximately half a roundtrip time incurred in memory access. This fast synchronization is referred to herein as “speed of light” (SOL) synchronization.

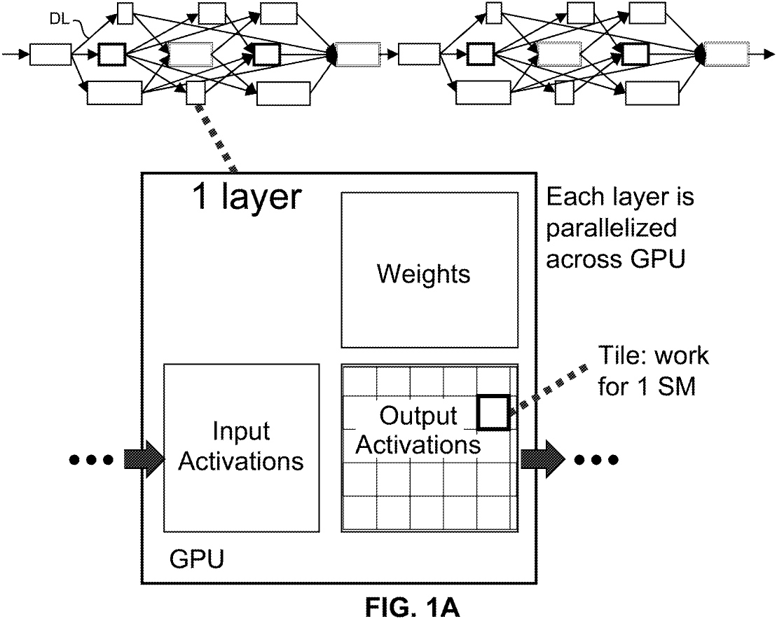

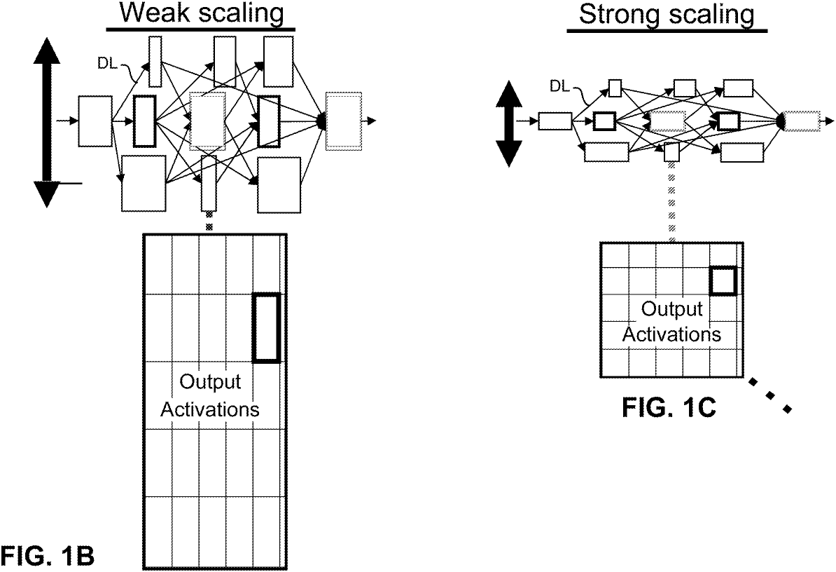

Strong scaling was described above in relation to FIGS. 1A-1C, and refers to GPU design improvements such that the same amount of work (compared to a previous generation of GPU) can be performed at multiple times the speed on a faster processor. This effectively reduces the tile size allocated to each processor. To achieve strong scaling, GPU designers prefer to have tiles that are as small as possible. The shrinking per-processor, such as, for example, a streaming multiprocessor (SM), workload size tends to hurt data reuse and thus requires higher data feeding rate. On the other hand, the math throughput within a SM also tends to increase in each generation, which also demands for higher data feeding bandwidth.

Since wires are expensive and do not scale as well as processing bandwidth, brute-force adding wires for extra bandwidth is no longer a feasible option. Instead, embracing locality is viewed as a more promising design choice. The goal of the embodiments described herein is to enable efficient data sharing and localized communication at a level greater than one SM while minimizing synchronization latency. Besides new cross-SM cooperation mechanisms, proper synchronization primitives play a critical role in such design.

Conventionally, CUDA provides the hardware named barrier as its core synchronization primitive which mostly follows the BSP (Bulk Synchronous Parallel) model. The arrive-wait barrier described in U.S. Pat. Application No. 16/712,236 filed Dec. 12, 2019 was introduced to better serve the producer-consumer style synchronization. However, named barriers and arrive-wait barriers while highly useful, each have their own weaknesses. For example, a hardware named barrier is a dedicated processor-local resource that provides a limited number of barriers and which is difficult to expose to software, may be incompatible with the thread programming model, may provide inefficient support for producer-consumer communication, and may be hard to extend to cross-processor synchronization. The arrive-wait barrier does not suffer from many of these disadvantages but is often implemented as a shared-memory backed resource that provides a software-polling based wait operation. Such an arrive-wait barrier may incur a latency exposure and a substantial bandwidth cost to shared memory traffic. For example, given the extensive additional cross-processor guaranteed concurrency the CGA programming model provides, more efficient cross-processor asynchronous data exchange and associated synchronization could result in substantial performance improvements by reducing bandwidth requirements across long data paths between parallel processors.

### Overview of Example GPU Environment

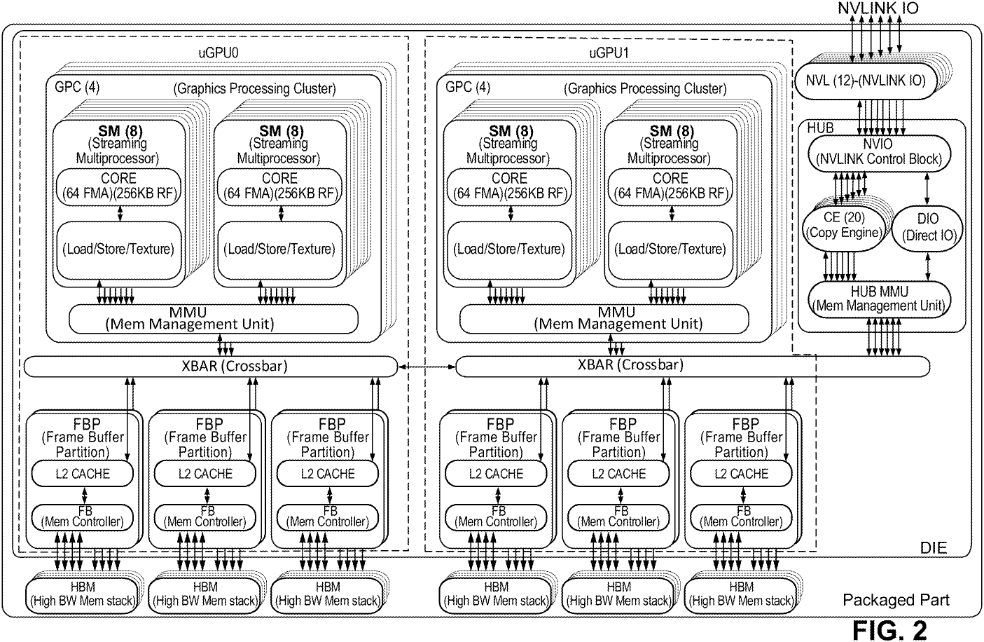

FIG. 2 shows an example GPU environment in which the new data synchronization may be implemented according to example embodiments.

The illustrated GPU shows how some GPU implementations may enable plural partitions that operate as micro GPUs such as the shown micro GPU0 and micro GPU1, where each micro GPU includes a portion of the processing resources of the overall GPU. When the GPU is partitioned into two or more separate smaller micro GPUs for access by different clients, resources -- including the physical memory devices such as local L2 cache memories -- are also typically partitioned. For example, in one design, a first half of the physical memory devices coupled to micro GPU0 may correspond to a first set of memory partition locations and a second half of the physical memory devices coupled to micro GPU1 may correspond to a second set of memory partition locations. Performance resources within the GPU are also partitioned according to the two or more separate smaller processor partitions. The resources may include level two cache (L2) resources and processing resources. One embodiment of such a Multi-Instance GPU (“MIG”) feature allows the GPU to be securely partitioned into many separate GPU Instances for CUDA (“Compute Unified Device Architecture”) applications, providing multiple users with separate GPU resources to accelerate their respective applications. More particularly, each micro GPU includes a plurality of Graphic Processing Clusters (GPC) each with a plurality of SMs. Each GPC connects to the L2 cache via a crossbar interconnect.

Each GPC includes a plurality of streaming multiprocessors (SM) that are each a massively parallel processor including a plurality of processor cores, register files, and specialized units such as load/store units, texture units, etc. A memory management unit (MMU) in each GPC interconnects the SMs on the same GPC, and also provides each SM with access to the memory including L2 cache and other memory. The GPCs in the same micro GPU are interconnected by a crossbar switch, and the micro-GPUs are interconnected by the respective crossbar switches. The GPU may additionally have copy engines and other IO units and links for external connections. For more information on prior GPU hardware and how it has advanced, see for example USP8,112,614; USP7,506,134; USP7,836,118; USP7,788,468; US10909033; US20140122809; Lindholm et al, “NVIDIA Tesla: A Unified Graphics and Computing Architecture,” IEEE Micro (2008); https://docs.nvidia.com/cuda/parallel-thread-execution/index.html (retrieved 2021); Choquette et al, “Volta: Performance and Programmability”, IEEE Micro (Volume: 38, Issue: 2, Mar./April 2018), DOI: 10.1109/MM.2018.022071134.

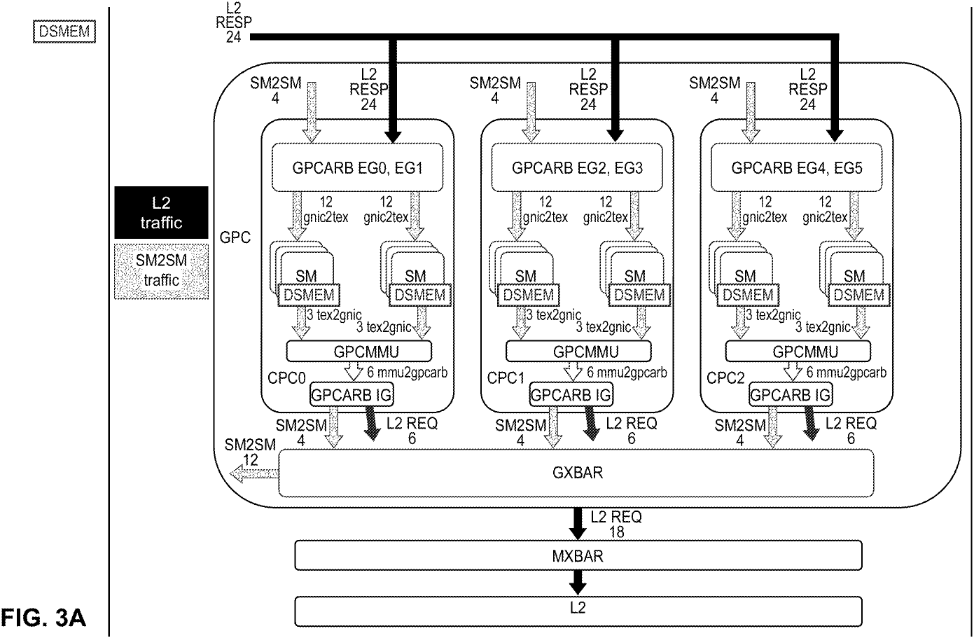

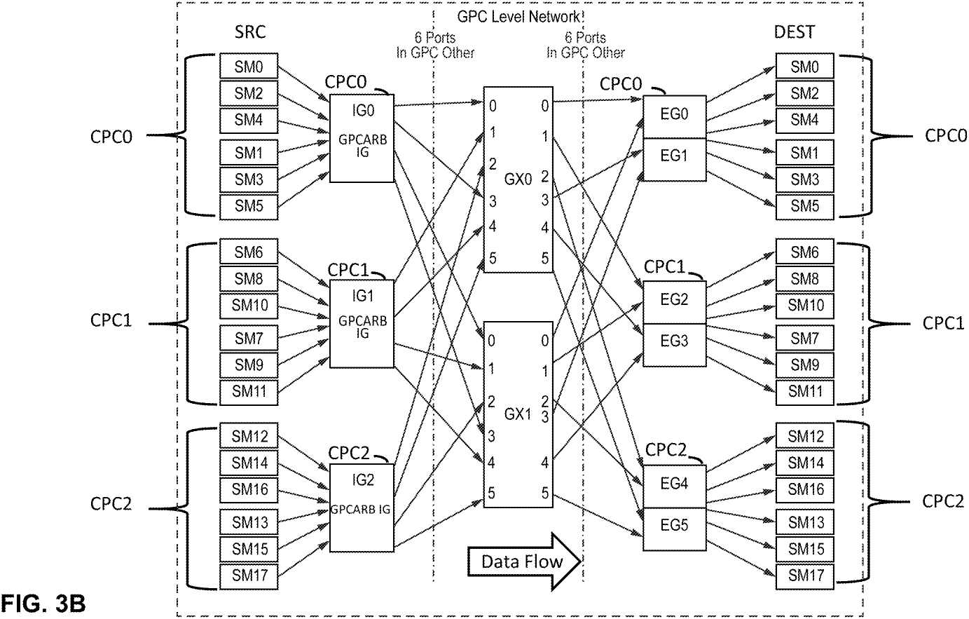

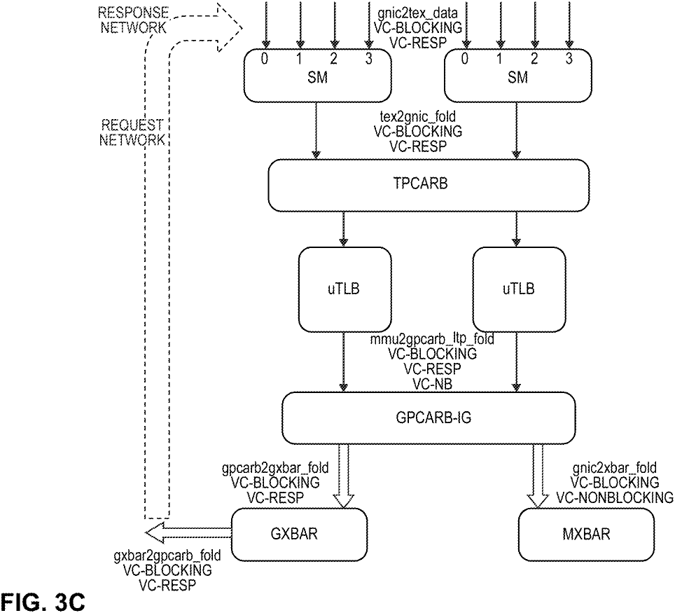

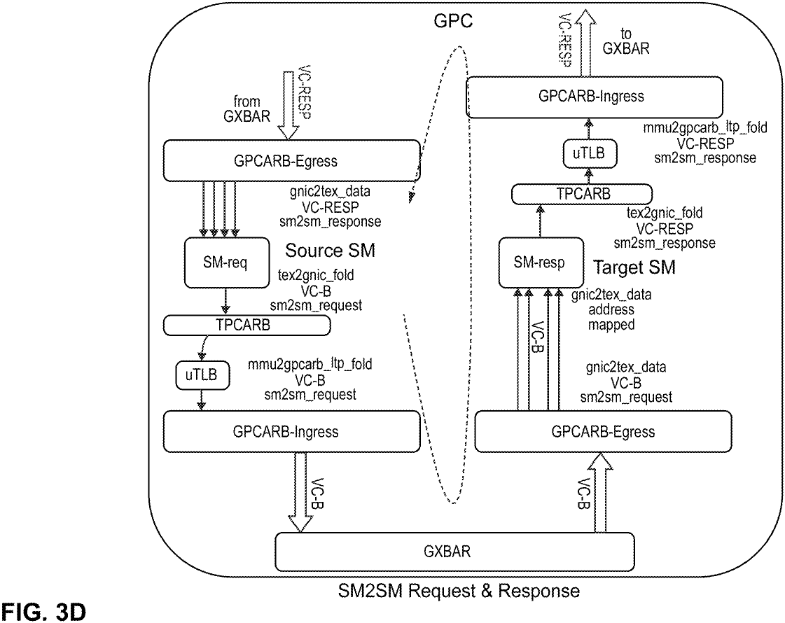

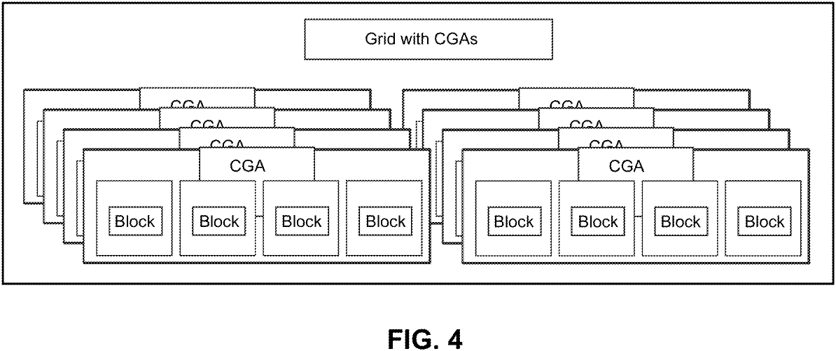

FIGS. 3A-3D show schematic illustrations of example inter-SM communication within a GPC in an example GPU such as that shown in FIG. 2. Inter-SM communication (“SM2SM” communication) occurs when a first SM transmits a message via a MMU to a crossbar that interconnects all the SMs in the GPC. Memory access requests to the L2 cache, are communicated through the same crossbar interconnect to the L2 cache. In some embodiments, the GPU includes a distributed memory such that inter-SM communication may include data operations from one SM to a portion of another SMs memory. An example distributed memory feature is described in U.S. Application No. 17/691,690. One of the messages that an SM can communicate to another SM is the local_cga_id of a CTA the SM is executing (CGA are described below in relation to FIG. 4). In one embodiment, the packet format of such an SM-to-SM message includes a U008 field “gpc_local_cga_id”. Each GPC has its own pool of CGA IDs, and GPM allocates one of those numbers to a CGA upon launch of that CGA. This assigned number then serves e.g., as a pointer into the DSMEM distributed memory segments that are being used by the various CTAs in the CGA. In one embodiment, the “gpc_local_cga_id” also serves as the id for tracking barrier state for each GPC_CGA.

FIG. 4 illustrates an arrangement of blocks of threads in a Cooperative Group Array (CGA), according to some embodiments. A CGA is a new programming/execution model and supporting hardware implementation and is described in the concurrently filed U.S. Pat. Application No. 17/691,621, which is herein incorporated by reference in its entirety. In some embodiments, the fast data synchronization described in this disclosure relies upon the CGA programming/execution model. The CGA programming/execution model enables adjacent tiles to be launched into SMs on the same GPC.

In one embodiment, a CGA is a collection of CTAs where hardware guarantees that all CTAs of the CGA are launched to the same hardware organization level the CGA specifies or is associated with. The hardware is configured to make sure there are enough processing resources in the target hardware level to launch all CTAs of the CGA before launching any.

As FIG. 4 shows, a CGA is a grid of clusters of thread blocks or CTAs organized as an array. Such CGAs provide co-scheduling, e.g., control over where clusters of CTAs are placed/executed in the GPU, relative to the memory required by an application and relative to each other. This enables applications to see more data locality, reduced latency, and better synchronization between all the threads in tightly cooperating clusters of CTAs.

For example, CGAs let an application take advantage of the hierarchical nature of the interconnect and caching subsystem in modern GPUs and make it easier to scale as chips grow in the future. By exploiting spatial locality, CGAs allow more efficient communication and lower latency data movement. GPU hardware improvements guarantee that threads of plural CTAs the new CGA hierarchical level(s) define will run concurrently for desired spatial localities, by allowing CGAs to control where on the machine the concurrent CTA threads will run relative to one another.

In one embodiment, CGAs are composed of clusters of CTAs that are guaranteed by hardware to launch and execute simultaneously/concurrently. The CTAs in a CGA cluster may -- and in the general case will - execute on different SMs within the GPU. Even though the CTAs execute on different SMs, the GPU hardware/system nevertheless provides a cross-SM guarantee that the CTAs in a CGA cluster will be scheduled to execute concurrently. The GPU hardware/system also provides efficient mechanisms by which the concurrently-executing CTAs can communicate with one another. This allows an application to explicitly share data between the CTAs in a CGA cluster and also enables synchronization between the various threads of the CTAs in the CGA cluster.

In example embodiments, the various threads within the CGA cluster can read/write from common shared memory -- enabling any thread in the CGA cluster to share data with any other thread in the cluster. Sharing data between CTAs in the CGA cluster saves interconnect and memory bandwidth which is often the performance limiter for an application.

Now, using the concurrent execution and additional shared memory supported by hardware, it is possible to directly share data between threads of one CTA and threads of another CTA - enabling dependencies across CTAs that can bridge hardware (e.g., cross-SM) partitions.

Because CGAs guarantee all their CTAs execute concurrently with a known spatial relationship, other hardware optimizations are possible such as: Multicasting data returned from memory to multiple SMs (CTAs) to save interconnect bandwidth as in embodiments of this disclosure; Direct SM2SM communication for lower latency data sharing and improved synchronization between producer and consumer threads in the CGA; Hardware barriers for synchronizing execution across all (or any) threads in a CGA; and more (see copending commonly-assigned patent applications listed above).

The additional cluster overlay provided by the CGA defines where and when the CTAs will run, and in particular, guarantees that all CTAs of a CGA will run concurrently within a common hardware domain that provides dynamic sharing of data, messaging and synchronization between the CTAs.

In example embodiments, all CTA threads within a CGA may reference various types of commonly-accessible shared memory. Hardware support in the GPU allows the different CTAs in a CGA cluster to read and write each other’s shared memory. Thus, load, store and atomic memory accesses by a first CTA can target shared memory of a second CTA, where the first and second CTAs are within the same CGA cluster. In some embodiments, the source multicast SM writes to the receiver multicast SMs in their respective memories using a distributed memory mechanism. An example distributed memory that may be used in embodiments is described in U.S. Application No. 17/691,690, which is incorporated herein by reference in its entirety. In some example embodiments, the distributed shared memory of the respective SMs is mapped into generic address space.

### The Problem of Synchronization

In a parallel processing multiprocessor system, communication between processors using memory located data “objects” may be slowed significantly by the latency involved in using memory barriers for synchronizing processes running on the different processors. An example of a memory barrier is a flag variable or other memory data structure that can be used to control the order of certain operations. Typically, a “producer” thread executing on one processor writes (also interchangeably referred to as “stores”) a buffer into memory, then writes a flag variable in memory to indicate the data is ready to be read (also interchangeably referred to as “load”) by a “consumer” thread executing on another processor. In many systems, between the last data write and the flag write, a memory fence or barrier operation is used to ensure the data writes are ordered before the flag write. This is done in order to prevent the consumer thread from seeing incomplete, non-updated or corrupted data.

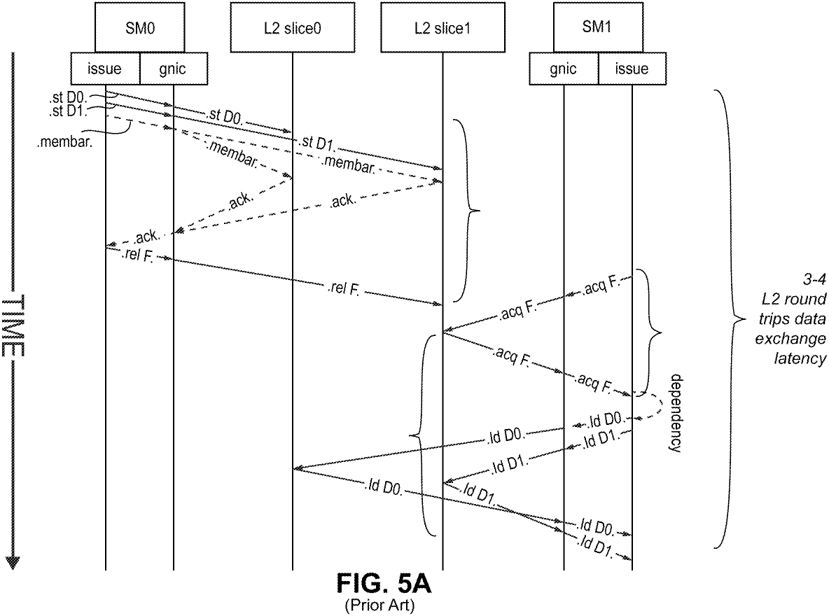

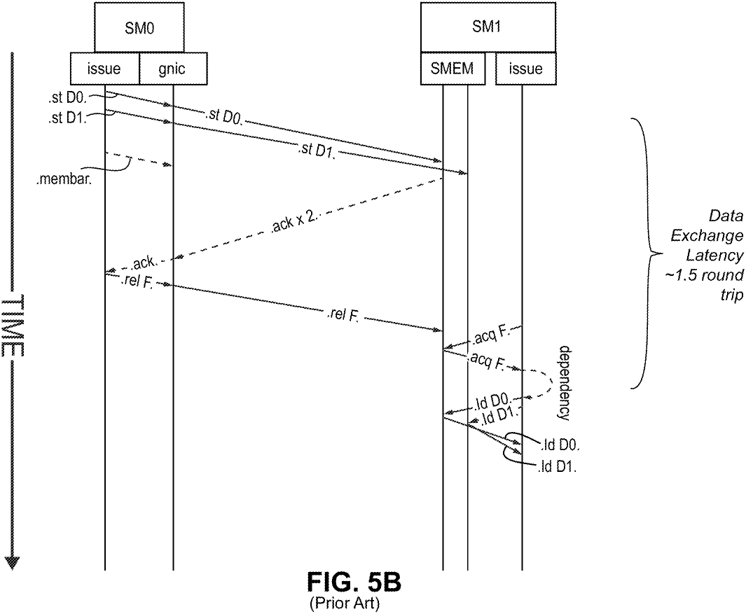

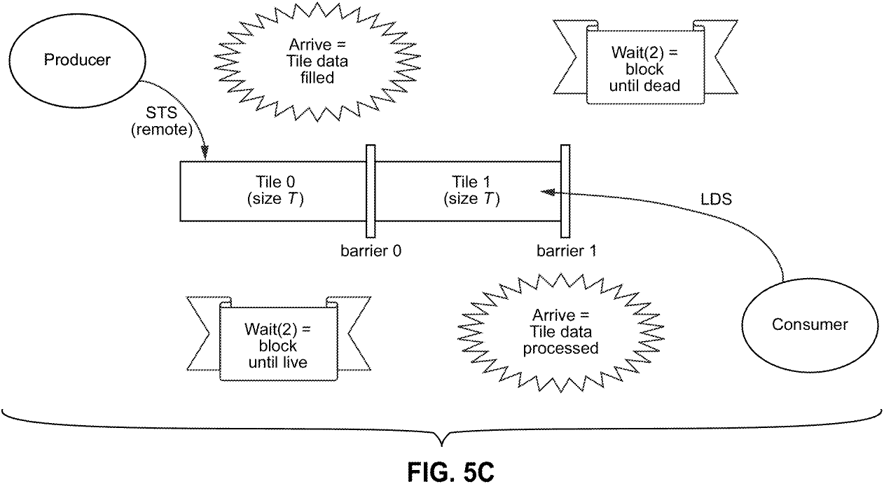

Generally this fence or barrier is expensive. That is, it has long latency. For example, FIG. 5A shows a conventional synchronized data exchange between two SMs (SM0, SM1) through a shared L2 cache in accordance with a conventional synchronization scheme. While the L2 cache is relatively close to SM0 and SM1 in the memory hierarchy, each L2 cache access represents a delay that increases latency.

The illustrated scenario involves SM1 as the consumer for data stored by producer SM0 in the L2 slice of SM0 (“L2 slice 0”) and in the L2 slice of SM1 (“L2 slice 1”). After the storing of data D0 and D1 to L2 slice 0 and L2 slice 1 respectively, producer SM0 waits for “ack” messages from the L2 caches for the memory barriers (“membar”) that were issued for the stored data, whereupon it updates a “flag F” to indicate that the data storing is complete. The membar instructions instruct the hardware to ensure visibility of the stored data to subsequent instructions such as those executed by consumer SM1. SM1 can acquire the flag F, as is necessary to load the stored data, only after SM0 updates the flag F by. Upon querying the L2 slices and successfully acquiring flag F, SM1 proceeds to load the data D0 and D1.

While the above sequence of operations successfully ensures synchronization of data between the producer and the consumer, three or four roundtrips of latency to/from the L2 cache may be consumed in the sequence from the time SM0 issues the store instructions to the time SM1 obtains the data in response to a load instruction,. Thus, according to this conventional scheme, the exchange of data incurs a latency cost of 3 to 4 roundtrips through the L2 cache.

A new generation of NVIDIA GPU implements various schemes for efficient producer/consumer parallelism for data orchestration, including, for example, inter-SM communication supporting SMs accessing memory of other SMs (described in U.S. Application No. 17/691,690; multicast over distributed shared memory (described in U.S. Application No. 17/691,288; and tensor memory access unit (described in U.S. Application No. 17/691,276 and in U.S. Application No. 17/691,422). In systems in which there exists shared memory with remote store capabilities in which SMs can access memory of other SMs without going through the memory hierarchy such as the L2 cache, the latency can be significantly reduced, provided that the data and the flag are co-located in the memory of one of the SMs such as the consumer SM. To exchange data in such systems taking advantage of the remote CGA store capabilities, the latency cost of data exchange may be decreased from the 3-4 of FIG. 5A to the equivalent of approximately 1.5 round trips through the L2 cache (assuming SM-to-SM latency is roughly equal to SM to L2 latency).

FIG. 5B shows an example data exchange sequence with synchronized data latency (remote) CGA memory best case according to a particular synchronization scheme. In the illustrated scenario, SM0 (more accurately, a thread running on SM0) stores the data D0 and D1 to the shared memory of SM1 (see U.S. Application No.17/691,690, which describes distributed shared memory). This is like dropping groceries off on your elderly neighbor’s doorstep - instead of running to the grocery store herself, your neighbor need only open her front door to get the groceries.

Upon receiving the acknowledgments for the stored data, the producer SM0 updates a flag F in the shared memory (SMEM) of SM1 to indicate that the stored data is available (like ringing your neighbor’s doorbell after dropping off the groceries except that the flag remains set for whenever the consumer SM1 cares to read it). The consumer thread on SM1 can wait on the flag F which is local in the consumer SM1′s own shared memory (and if necessary, can “acquire” the flag when it is updated by SM0) before issuing the load for the newly written data D0 and D1 out of its own local memory. This data exchange, assuming that the SM-to-SM communication through shared memory has latency that is roughly equal to the latency of SM-to-L2, incurs a latency cost of only approximately 1.5 roundtrips because the amount of time it takes for SM1 to read from its own local memory is very fast.

Each scheme for efficient producer/consumer parallelism for data orchestration, such as the schemes for efficient producer/consumer parallelism noted above, addresses the same fundamental two synchronization challenges:

(A) When is the consumer ready to receive new data (e.g., a tile has become dead)? and

(B) When is the consumer ready to begin processing filled data (e.g., a tile has become alive)?

The embodiments described in this disclosure solve these two problems using the same unified mechanism, as they are fundamentally two sides of the same coin. The embodiments leverage some aspects of the arrive-wait barriers, introduced in a previous generation of NVIDIA GPU, as the basis for producer/consumer communication. Although the embodiments are described in this disclosure primarily in relation to shared memory, some embodiments may be applied to global memory or combinations of shared memory and global memory.

Consider a producer and consumer communicating through shared memory. FIG. 5C shows another representation of the scheme shown in FIG. 5B. In the scenario shown in FIG. 5C, the shared memory buffers are represented as “Tile 0” and “Tile 1”. Flags “barrier 0” and “barrier 1” are configured to synchronize data exchange on Tile 0 and Tile 1, respectively. The producer performs a remote StoreShared (shown “STS”) operation to write data to Tile 0 using a data movement scheme (such as e.g., using the tensor memory access unit (TMAU) as described in (6610-91) or programmatic multicast described in 6610-97), and then uses an arrive operation on “barrier 0” to indicate the presence of the data in Tile 0. The producer’s arrive operation releases the consumer from its wait() on barrier 0. Similar synchronization occurs on Tile 1 based on barrier 1. Conversely, after being released from its wait() operation on a barrier, the consumer processes the tile and then uses an arrive on the corresponding barrier to release the producer from the wait() operation of the producer. Therefore, the producer and consumer use different semantic interpretations of arrive and wait in order to synchronize. For the producer, arrive represents “tile has become dead” (a situation in which the consumer consumes the data of the tile, and the tile has become empty). For the consumer, arrive represents “tile has become live” (a situation in which the producer has stored data to the tile, and the tile has data to be consumed).

Example embodiments further address a practical issue relating to reliance on the memory ordering between the store operation and the arrive operation. In massively parallel multithreaded machines, operations are sometimes or even often opportunistically performed out of order in order to reduce execution latency. For example, the store operation and the arrive operation may be often reordered in the GPU e.g., due to hit under miss, or differing transfer distances from L2 slices. In situations in which both the producer and consumer are on the same SM, reordering does not, or is very unlikely to, occur frequently. For example, the “ARRIVES.LDGSTSBAR” instruction, introduced in a previous generation of Nvidia GPUs, depends on the producer performing the data store instruction “LDGSTS” and the consumer issuing the load “LDS” being on the same SM. However, with the introduction of CGAs, multiple CTAs running on different SMs may now be synchronizing across SM boundaries. While the CTAs are all guaranteed to be running concurrently, the concurrency guarantee in one embodiment does not extend to ordering execution on one SM relative to execution on another SM(s). Without solving this problem of maintaining ordering in the face of possible re-ordering of store operations and arrive operations when producer and consumer are on different SMs, the arrive/wait technique of synchronization may not be very useful for distributed producer/consumer synchronization. Accordingly, some embodiments include solutions for maintaining such ordering across SM boundaries.

### Improved Synchronization in NUMA-organized Systems

When threads running on multiple processors in a non-uniform memory access (NUMA)-organized system (or subsystem) are aware of the location of the thread they are communicating with (for example, which processor it is on) and are able to target the communication data writes and flag write to the memory physically associated with that destination processor, then there is an opportunity to achieve optimally fast data synchronization. The optimally fast data synchronization is achieved by updating the flag mentioned above immediately (or without significant delay) after writing the data.

In order to solve the problem of maintaining ordering in the face of possible re-ordering of stores and arrives, example embodiments provide a new combined (remote) store and arrive (“STS+Arrive”) instruction. In an implementation, upon receipt of the combined store and arrive operation in the destination processor, the data is written to a receive buffer, and a barrier, on which another process (a consumer thread) may perform a wait() operation to obtain access to the receive buffer in order to read the data, is updated to indicate that the data has been written. This instruction specifies two addresses in the same SM shared memory: (A) the address to write the data to (e.g., an address associated with the receive buffer), and (B) the address of a barrier to update when the store is completed. According to one implementation, a parameter for the wait() operation to be cleared is set to be equal to the number of lines (T) in the tile. Thus the consumer thread passing (i.e. being able to process instructions beyond) the barrier indicates that the tile has been filled. Note that T is a free variable (as is the number of resident tiles), and so software can adjust the space-latency tradeoff in order to hide average fill latency for tiles.

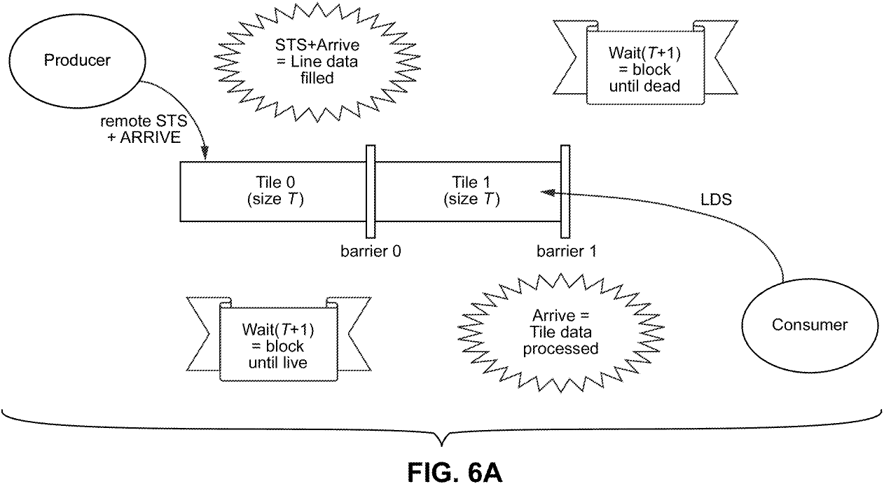

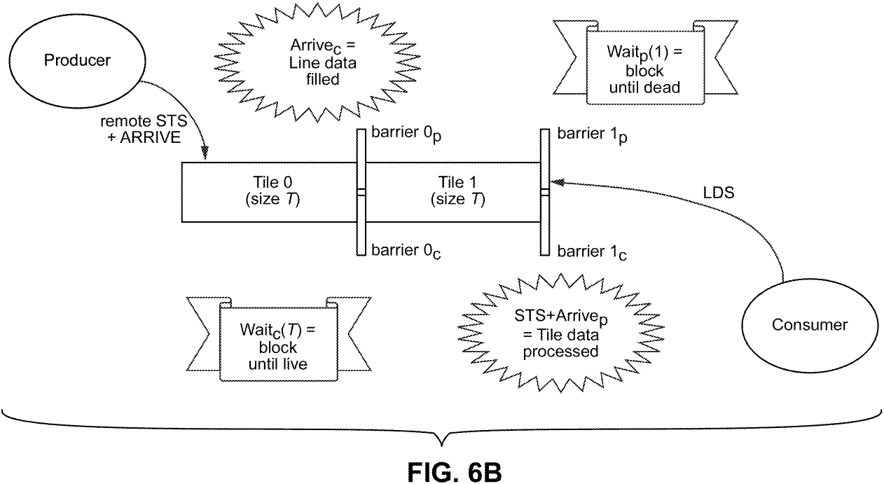

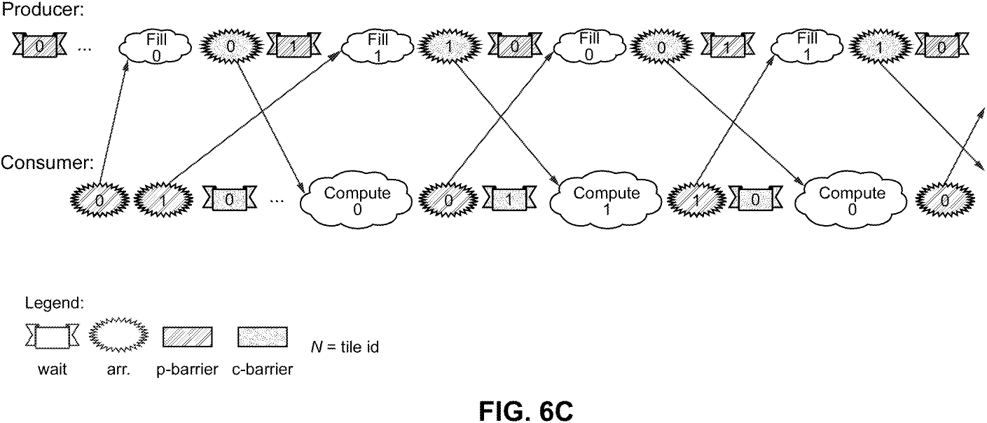

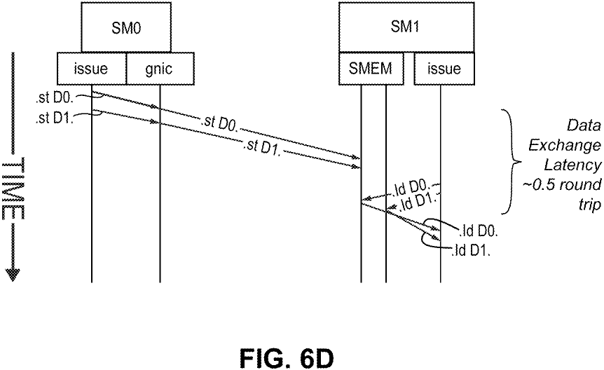

The scenario of FIG. 6A illustrates the producer issuing a remote combined store and arrive instruction. This scheme can seamlessly extend to multiple producers each storing a separate section of the same tile, as the consumer may be agnostic to the source of the arrive operations.

However, this scheme shown in FIG. 6A still has what may be a shortcoming: it relies on the producer performing a remote wait() on the consumer SM’s barrier which the producer has written into the consumer’s local memory - meaning it is now remote to the producer. This remote wait() can be expensive and/or in some cases even impractical to implement due, for example, to the cost of implementing remote polling. The techniques described in this disclosure improve upon the above for a solution that avoids performing such a remote wait() operation.

In one embodiment, the remote wait() is avoided by splitting the synchronization functionality across two barriers: one co-located with the consumer, and one co-located with the producer. This imposes a relatively minor space overhead, yet removes all need for remote wait() functionality. In this scheme, the “c-barrier” (a barrier co-located with the consumer) is waited on (e.g. using wait() instruction) by the consumer and arrived on (e.g. using arrive()) by the producer. Conversely the “p-barrier” (a barrier co-located with the producer) is arrived on by the consumer and waited on by the producer.

The embodiments according to FIGS. 6B-6D introduces an improved instruction set architecture (ISA) feature - namely the combined store and arrive instruction, a new form of store instruction, and associated memory transactions in which a data write and a separate flag update are packaged together as one combined operation. The at least two addresses in the instruction, the data address and the barrier (flag) address, each map to the memory associated with a thread on a destination processor in the NUMA-organized system or subsystem. The new store instruction also takes a data operand. The new store instruction’s effect is to first write the data specified by the data operand at the data address, and then update the flag or barrier at the barrier address. The update to the flag is performed substantially simultaneously to the writing of the data, so that no significant delay between the two operations exist in which another change to the written data could occur.

In some example embodiments, the barrier is atomically updated by adding the number of bytes of data that were written. Utilization of this by software means that in one embodiment, the software knows the number of bytes expected to be written in the buffer in order to synchronize. The receiving thread (also referred to as destination thread) in principle waits on the barrier reaching a certain expected value so that the barrier reaches a “clear” condition. The expected value, for example, in some embodiments, may correspond to the number of bytes or other measure of data that will be written by sending threads (also referred to a source thread).

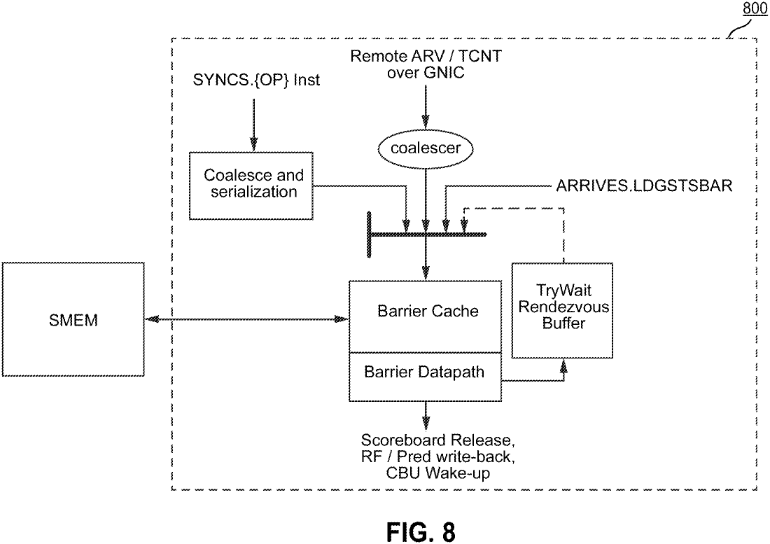

In one embodiment, a barrier support unit, such as the hardware-implemented synchronization unit described in U.S. Application No. 17/691,296, the entire description of which is incorporated herein by reference, may be used to accelerate the barrier implementations by enabling the receiving thread to simply wait on the barrier “clearing”. The hardware-implemented synchronization unit in U.S. Application No. 17/691,296 handles the details of waiting for the count to be reached. However, the receiving thread software does have to know the expected byte count and supply it to the barrier support unit. An example barrier support unit is shown in FIG. 8 of this application.

Since the barrier is managed atomically (all accesses are atomic), some example embodiments allow multiple other threads on the same processor or multiple other processors to cooperate in sending data to one receiving thread. To use this, one embodiment assumes that the software understands to write each element of the data buffer once (possibly from different source threads) and that the receiving thread knows the expected byte count. In one embodiment, the byte count is not required to be static and the sending threads can use this barrier support unit to update the expected byte count before or in parallel with doing this disclosure’s special stores with barrier update. Example embodiments (optionally, with the assistance of the barrier support unit) supports dynamically sized data buffers. The result is that data can be written and the barrier updated with no significant delay after the data write.

FIG. 6B shows producer barriers “barrier 0p” and “barrier 1p” that are local to the producer, and consumer barriers “barrier 0c” and “barrier 1c” that are local to the consumer. The producer performs one or more remote combined store and arrive operations, each of which fills a tile with line data and performs a remote arrive operation on the corresponding barrier and calls wait() on the local producer barriers to block until the tile becomes dead (i.e. has no data) again. Each consumer, which was waiting on a consumer barrier until the corresponding tile became live (i.e. have data to consume), would be released in response to the producer’s remote arrive operation on the consumer’s local barrier and proceeds to load (“LDS”) the data from the tile. The consumer issues a remote arrive operation on the producer barrier to indicate the data in the tile was read, and then waits on the local consumer barrier until the tile becomes live again. The producer, upon being released from the wait() in response to the remote arrive operation by the consumer on the producer barrier, proceeds to again fill the tiles by one or more remote combined store and arrive operations.

Therefore no SM, more specifically neither a producer thread nor a consumer thread, is waiting on a barrier that is not in its own local shared memory. Since a remote wait() is not required, this new technique can utilize a wait() call similar to that used in a previous generation of NVIDIA GPU without modification - that is, the wait() operation for either of the consumer thread or the producer thread is on a local barrier in a memory of its own SM.

Another new aspect in the introduced synchronization is the remote arrive operation from the consumer to the p-barrier (indicating tile has become dead). In some example embodiments, this can be implemented with the same combined store and arrive operation functionality described above (e.g., with a dummy store address). This could be optimized further by adding a remote arrive operation that does not need a store (STS) component. Note that in the multi-producer scenario (e.g., where several producer threads, possibly in different processors, store to the same buffer) described above, a separate combined store and arrive operation is sent to each producer in one embodiment. However, if a multicast scheme (e.g., programmatic multicast described in US 17/691,288) is implemented, then this combined store and arrive can be multicast to those producers.

FIG. 6C illustrates an example of the synchronization according to an embodiment with two tiles (tiles 0 and 1), each tile having a corresponding p-barrier and a corresponding c-barrier. In the figure, the tile number is illustrated within the representative icon of the tile or barrier. The p-barriers and c-barriers are indicated by diagonal line fill pattern and a dotted fill pattern, respectively.

At the beginning of time (i.e. beginning of the illustrated synchronization sequence), there may be a (safe) race between loading the program for the producer thread on the producer SM and the consumer thread on the consumer SM. Assuming that the producer wins, time then proceeds as follows (logical time steps 0-4):
0) The producer begins to wait() on the p-barrier for tile 0.
1) The consumer arrives() at the p-barrier for tiles 0 and 1 (since both are initially dead), then waits() on the c-barrier 0.
2) The arrival at p-barrier 0 frees the producer, who fills Tile 0, performing combined STS+Arrive for c-barrier-0 (optionally with multicast to many consumer SMs) and waits() on p-barrier 1.
3) The final STS+Arrive frees the consumer from c-barrier 0, and it begins the consumption of Tile 0, then arrives() on p-barrier-0 and waits() on c-barrier 1.
3) (Purposely concurrently on the same time step.) The previous arrive() on p-barrier 1 represents that the producer is freed and can fill tile 1.
4) Steady-state is achieved if the average the roundtrip latency between producer/consumer (or the tile computation time) is greater than the tile size T.

As noted above, software may, as necessary, dynamically or as configured, trade T off against the number of total resident tiles in order to achieve optimum workload-specific throughput.

FIG. 6D shows another example message flow according to example embodiments, and more clearly illustrates how the data exchange synchronization is achieved with a latency of approximately 0.5 roundtrip time. One roundtrip time here represents the time for a message from the thread (e.g. producer process) on SM0 to reach SM1 (e.g. the shared memory of SM1) and return to SM0. For purposes of this disclosure, the term roundtrip latency also represents the latency for a message from a thread on a SM to reach L2 cache memory and to return too.

This type of fast synchronization achieved with less than a roundtrip latency is, as mentioned above, referred to in this disclosure as “speed of light” or “SOL” synchronization. In some embodiments, SOL synchronization covers the cases of an object (e.g., a set of one or more memory locations) located in a DSMEM (distributed shared memory) location in a particular destination CTA with one or more other CTAs (in the CGA) writing to the object and then in an SOL manner alerting the destination that the object is ready for use (e.g., that writes are completed and visible).

For two concurrently executing threads (or processes) on processor 1 and processor 2, an expected usage of the synchronization of example embodiments may be as follows: processor 1 executes the sequence ST D0, ST D1, REL; and processor 2 executes the sequence ACQ, LD D0, LD D1. The ST D0 and ST D1 operations are combined stored and arrive operations. FIG. 6D depicts the example SOL synchronized data exchange. In the figure, SM0 issues combined store and arrive instructions to store D0 and D1 in the shared memory of SM1. When D0 and D1 are written to SM1 and the barrier on SM1 is updated by the arrive of the combined store and arrive operations, SM1 acquires the barrier (e.g., the wait() on that barrier is released) and loads D0 and D1. The latency incurred is due to the latency of SM0 to SM1 store messages and the latency of the local wait for SM1, thus yielding approximately 0.5 roundtrips of latency. Due to the employment of the combined store and arrive instructions, the sequence of FIG. 6D can be more particularly specified as: processor 1 issues two instructions that are a store D0 and partial release of barrier and store D1 and another partial release of the barrier; and processor 2 performs an acquire on the barrier (wait at partial release), and load D0 and D1.

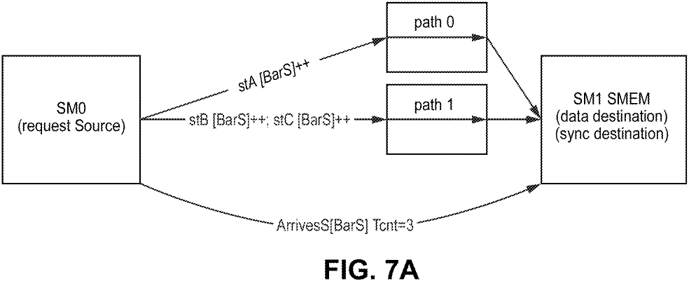

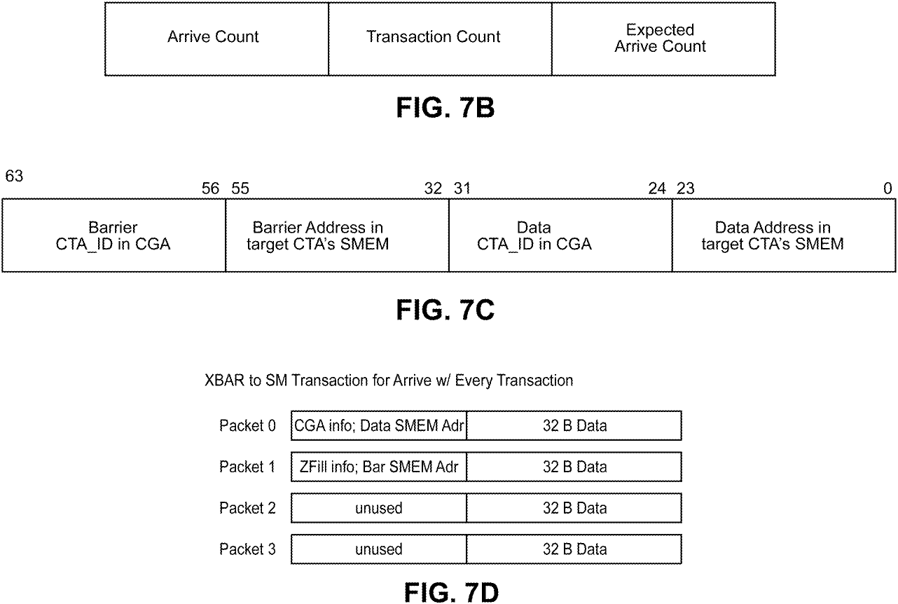

According to example embodiments, the combined store and arrive instructions that store to the same buffer are not required to take the same path from SM0 to SM1. For example, FIG. 7A shows a scenario in which the combined store and arrive instructions between the same pair of SMs take different paths. The different paths may be through the one or more interconnect switches that connect SM0 to SM1. Combined store and arrive instruction A (“stA[BarS]”) travels through path 0 in the interconnection switch from the first SM to the shared memory of the second SM, whereas the combined store and arrive instruction B and C (“stB[BarS]” and “stC[BarS]”) travel on a different path in the interconnection switch, path 1, to the other SM’s shared memory. Each of the store instructions increments the same barrier (“BarS”) in accordance with the information regarding the data stored by that instruction. The same destination shared memory is the data destination as well as the synchronization destination. That is the same shared memory includes the receive buffer for the data of the combined arrive operations, and also the barrier updated by the combined arrive operations. Thus, by using the combined store and arrive instructions for performing full or partial updates of the same barrier upon each store, example embodiments avoid imposing any requirements of having to transmit fence flush instructions or any other ordering requirements.

An example transaction barrier structure that includes an arrive count, an expected arrive count, and a transaction count is shown in FIG. 7B. FIG. 7C shows an example instruction format for the combined store and arrive instruction. The instruction format may include at least four fields: the CTA-ID of the target CTA in which the barrier resides, the address of the barrier in the target CTA’s shared memory, the CTA-ID of the target CTA in which the data destination is, and the address of the data destination in the target CTA’s shared memory shared memory. FIG. 7C also shows example non-limiting sizes for the respective fields: 24 bits each for the barrier address and the data address, and 8 bits each of the barrier CTA-ID and the data CTA-ID. Alternate embodiments may encode multiple target CTA-IDs in a bit-mask for a multicast operation (similar to U.S. Application No. 17/691,288, already incorporated by reference).

Returning to FIG. 7A, it is shown that an arrive operation on the barrier updates (e.g., in this embodiment decrements) the transaction count of the barrier with an expected transaction count of 3, and each of the combined stored and arrive operations increments the transaction count of the barrier by 1. Thus, when the transaction barrier reaches 0 the barrier is cleared.

FIG. 7D illustrates an example non-limiting manner in which the instruction format of FIG. 7C can be implemented in a fixed-size packet structure of a processor environment. The example implementation transmits the data address in the target SM shared memory in the first packet and the barrier address in the destination SM shared memory in the second packet. While this implementation requires at least two packets to represent a combined store and arrive instruction, the implementation enables the use of more packets if more data is to be stored.

FIG. 8 is a schematic block diagram of a hardware-implemented barrier support unit 800 in accordance with some example embodiments. Synchronization unit 800 may be used, in some example embodiment, to accelerate the synchronization operations described above. The barrier support unit 800 is described in U.S. Application No. 17/691,296, the entire description of which is incorporated herein by reference. The barrier support unit 800 may accelerate the barrier implementations by enabling the receiving thread to simply wait on the barrier “clearing”. The hardware-implemented synchronization unit in the U.S. Application No. 17/691,296 handles the details of waiting for the count to be reached. However, the receiving thread software does have to know the expected byte count and supply it to the barrier support unit.

### Instruction Set Architecture

In the embodiments described in relation to FIGS. 6B-6D, if a buffer is claimed to be filled, loads to that buffer should be simply allowed to block waiting until the fill occurs. Being able to clearly define the buffer or location filled event is helpful. In one embodiment, this involves advance setting up of expectation on how many updates are to be expected before the data is considered ready to use. To efficiently support physically distributed buffers (e.g., including those in shared memory or in L2 cache / framebuffer), the expectation is decomposable to localize the tracking effort of buffer fill.

Two new instructions are implemented to support the above described SOL synchronization in some example embodiments: a “Store with Synch” instruction and a “Reduction with Synch” instruction.

The Store with Synch instruction and the Reduction with Synch instruction may be exposed to the programmer through a library interface. In some embodiments, the store may be regarded as invalid unless addressed to shared memory located in another SM belonging to a CTA that is part of the same CGA as the source CTA. The instructions may support one or more operand sizes, such as, for example, 32 bytes, 64 bytes, 128 bytes, etc. A barrier address and a data address are provided as input address parameters. Specifically, the barrier address is represented by CTA_ID in CGA of barrier (which in some embodiments must be the same as the CTA_ID in CGA of the data) and the shared memory offset (address) of the barrier at the target. The data address is represented by CTA_ID in CGA of the data location and the shared memory offset (address) of the data at the target.

The Store with Sync instruction provides a SOL CGA memory data exchange using a synchronization that travels with a store. The instruction may be of the form:
ST_CGA_Sync Ra, Rb
Ra: target addresses, contains
   CTAID(s) of target CTA(s) - multicast by specifying multiple CTA IDs.
   DataAddr: shared memory (SMEM) offset in CTA to perform store to.
   BarAddr: shared memory offset in CTA to perform barrier update to.
Rb: data to store.

This instruction stores data to target/destination CTA(s) SMEM[DataAddr]. After data store is guaranteed visible, it decrements the transaction count field of barrier at target CTA(s) SMEM[BarAddr] by the amount of data (e.g., number of bytes) being stored.

The Reduction with Synch instruction does shared memory atomic reductions instead of stores. The instruction may have a format such as:
REDS_CGA.ARRIVE_TCNT URa, URb
Where URa: target addresses, contains,
   CTAID(s) of target CTA(s) - multicast by specifying multiple CTA IDs.
   BarAddr: SMEM offset in CTA to perform barrier update to.
URb: expected transaction count (e.g. in bytes).

The reduction instruction performs an arrive reduction operation for the number of threads executing the REDS. The arrive reduction operation may be the same as for arrive atomic. The instruction may increment the transaction count in the destination barrier by the number specified in URb. The reduce instruction noted above may be used in some embodiments to sum up all the counts for all the individual threads and store it into URb.

In some embodiments, the instruction format may also be built to track the number of stored bytes explicitly. In this scheme, the Store-with-synch instruction also maintain a running count of number of bytes as below.
ST_CGA_Sync [Addrs], Data, TCount
where Addrs: target addresses, contains
   CTAID(s) of target CTA(s) - multicast by specifying multiple CTA IDs.
   DataAddr: SMEM offset in CTA to perform store to.
   BarAddr: SMEM offset in CTA to perform barrier update to.
Data: data to store.
TCount: The running byte transaction count.

The operation of the instruction may be as follows:
Stores the data to target CTA(s) SMEM[DataAddr].
After data store is guaranteed visible, decrements by number of bytes being stored to ByteTransactionCnt (number of bytes written) field of barrier at target CTA(s) SMEM[BarAddr].
Increment the TCount by the number of bytes being stored.

The corresponding Reduction-with-Synch instruction may be as below:
RED_CGA_Arrive [BarAddr], TCount
Where BarAddr: Target barrier address, which contains:
   CTAID(s): Target CTA(s). Multicast by specifying multiple CTA.
   IDsBarAddr: SMEM offset in CTA to perform barrier update to.
TCount: The byte transaction count of the thread.

This instruction performs an arrive reduction to barrier in CTA(s) SMEM[BarAddr]. The instruction reduces the TCount across all the threads, and then increments the ByteTransactionCnt field of barrier at target CTA(s) SMEM[BarAddr] by the total TCount.

### Other Implementations

In another embodiment, there is also a barrier located in the same (processor affiliated) memory unit as the destination data buffer, in a manner similar to an above described embodiment. However, instead of updating the barrier with the number of bytes written (or updating the barrier with some other measure of the amount of data written to the data buffer) as in the above described embodiment, in this other embodiment, sending processor(s) write as much data as desired (and/or allowed) to the destination thread’s memory (NUMA associated with the destination thread), and then send a memory write fence operation. To help clarify, it helps to realize that the memory system network (e.g., NOC, network on chip) will typically have multiple paths between any two processors in a multiprocessor and a subset of these paths can be used for transmitting write operations from a source thread on a source processor to a destination thread on a destination processor. The total number of possible paths may be implementation dependent, but may be known at startup time and may remain fixed after startup. In this alternative embodiment, the sending processor replicates the fence to be sent on all paths (the fence is sent after the write on the same network paths that write could have taken, but the fence is replicated to all paths on which writes might have travelled). Each arriving fence increments the barrier at the destination one time. The destination thread waits on the known count (expected number of fence arrivals) that is the known number of possible paths from the source processor to the destination processor. When all the fence messages for the store operation by the source SM have arrived at the barrier, the counter in the barrier indicates that all the expected fence messages have been received and therefore all stores have already been received at the destination processor. When the barrier clears, the consumer process, which may be waiting at the barrier, begins to load the data received data.

In a particular implementation, after initial runtime configuration, the number of paths between any two processors is considered to be a static unchanging number. An advantage of this other embodiment in comparison to the embodiment in which the barrier is updated with each store operation, is that the communicating threads are not required to know and communicate the number of bytes written beforehand. Thus, this embodiments may be useful for the many applications for which it is difficult for software to determine the number of bytes to be written. For example, if a subroutine is called to do some of the data writes, it may be difficult for the calling code to know how many bytes the subroutine writes. This alternative implementation avoids that problem of the destination having to know the amount of data it is expecting.

This alternative embodiment yields lower latency than the conventional synchronization scheme described in relation to FIG. 5A, that of writing data and then doing a generic write fence that is generally expensive, then writing a flag. The latency for this alternative embodiment would be higher than 0.5 roundtrip time due to the fence operations, but is expected to be less than a roundtrip time and since the fence operation can immediately follow the store operation and no separate flag update operation is required to be sent from the source processor. That is, the elapsed time between the data being written in response to the first message being received and the barrier being updated in response to receiving the fences is less than the one-way time from the source thread to the destination (e.g., less than the elapsed time between the source thread sending first message and the first message being received at the destination thread or destination processor).

In CGA environments, an example embodiment provides for CGA memory object-scoped SOL synchronization of SM2SM communication in the context of CGA memory. This relates to inter-SM stores to CGA shared memory hosted within SMs in their respective shared memory storage. The feature may be utilized between multiple SMs on the same GPC, or on multiple GPCs. In some embodiments, the inter-SM stores may utilize L2-hosted CGA shared memory.

A key architecture aspect and hardware support for this embodiment is a fence operation that is directed at one other CTA in the CGA running on a different SM (it may also apply for CTAs running on the same SM). The fence instruction specifies a target CTA (which, for example, hardware mapping tables can map to a target SM). It also specifies a barrier address. In some embodiments, the specified barrier address may be located in the CTA’s global memory region (e.g., in the partitioned global address space (PGAS) of the CTA). The fence travels on all paths that stores from the source SM to destination SM could travel in the interconnect (crossbar or other switch) interconnecting the SMs. Doing so sweeps all prior stores from the source SM to the destination SM ahead to the destination. That is, the fence cannot arrive at the destination SM on all paths until all stores prior to the fence have arrived at the destination SM.

The fence arrives at the destination SM once per path. Each fence arrival event causes the destination SM to do a fence arrive operation on the barrier in the destination SM. Although a fence arrive may be more complicated than simply an atomic decrement (or increment, depending on implementation) of the barrier location, for purposes of this description one may simply consider it as that.

In the simplest use case, the program on the destination SM knows how many fence arrives to expect. The number of paths through the memory system for these inter-SM stores may be a fixed hardware value available to the program. The program could in this case initialize the barrier to N, the number of paths, and then poll the barrier until it is zero. A value of zero would mean the fence had arrived on all paths and on each arrival the fence count of the barrier was decremented.

A more complicated use case involves multiple sending CTAs being required to, in effect, initialize the barrier prior to the expected fence arrival count. The fence arrivals may be regarded as “transactions”. The software layer operates in terms of messages, and sending and receiving CTAs agree on how many messages will arrive. Those messages are “arrivals”. With each “arrival” the software, optionally with help from hardware, adjusts the barrier’s expected transaction count (i.e., number of paths * number of messages).

An example programming model for this embodiment may be as described next. The destination CTA has an object barrier in its local memory, which it may initialize before the synchronization operation. The destination CTA communicates “space available” to one or more source CTAs when a designated buffer in the CGA shared memory of the destination CTA becomes available.

The destination CTA executes a wait on the object barrier. One or more source CTA(s) write bulk data to the designated buffer in the destination CTA’s CGA shared memory, and then executes a fence and arrive targeting the object barrier in the destination CTA’s memory. When the destination CTA is released from the wait on the object barrier, it may then read bulk data from shared memory.

An example implementation may be as described next. The memory object barrier in the destination CTA local shared memory may be a word with several fields. The fields may include an expected arrive count, actual arrive count, and a fence transaction count. In an example implementation, the arrive counts may be made visible to software, but the fence transaction count may be hardware managed and opaque to software. The fence transaction count, and/or any of the other fields of the memory object barrier can be positive or negative. The barrier can be initialized with a target value for the expected arrive count, and the fence transaction count can be set to 0.

The fence and arrive instruction may be executed by the source CTA(s) after writing arbitrary bulk data to destination CTA. Alternatively, in some embodiments, the fence and the arrive can be split to two instructions. The source CTA(s) can each send its fences down all N possible address paths to destination SM (e.g. N=4 paths). Each fence includes the address of the memory object barrier. The arrive may be sent down any path to the destination SM, whereas the arrive may be unordered with respect to the fence transactions.

Fence instructions follow and flush previous memory instructions, if any, on each path from the source SM to destination SM. At the \destination SM each fence instruction increments the transaction count in the memory object barrier. Also, at the destination, arrives increments the arrive count in the memory object barrier. Further at the destination, the arrives decrements the fence transaction count in the memory object barrier by N. Fence and arrives do not need to be ordered with respect to each other in the case of multiple source CTAs synchronizing on one destination CTA’s memory object barrier.

A barrier wait instruction executed at the \destination SM may take the barrier address as a parameter and may return “clear” status when (arrive count == expected arrive count) && (fence transaction count == 0). Note, that the fence transaction count is incremented by fence instructions and decremented by arrives, and the destination CTA may wait until it resolves to 0. Note also the assumption that N is statically known in hardware (e.g. 4). If N is not known, the arrive may carry the N.

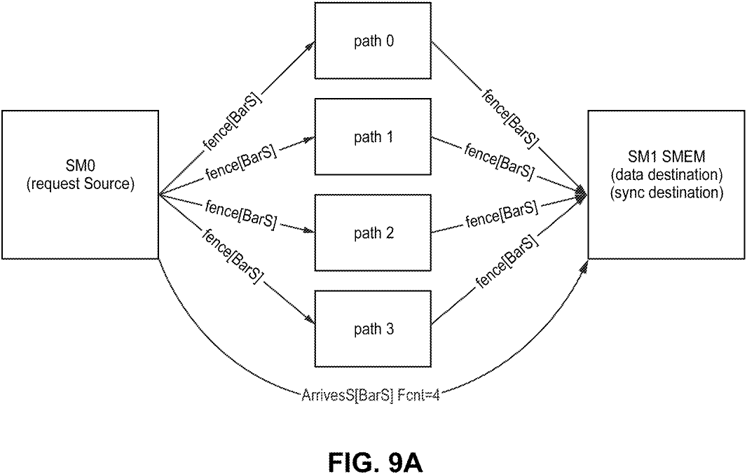

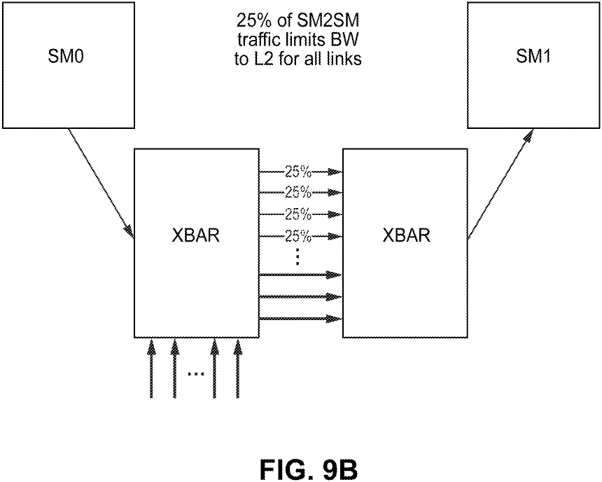

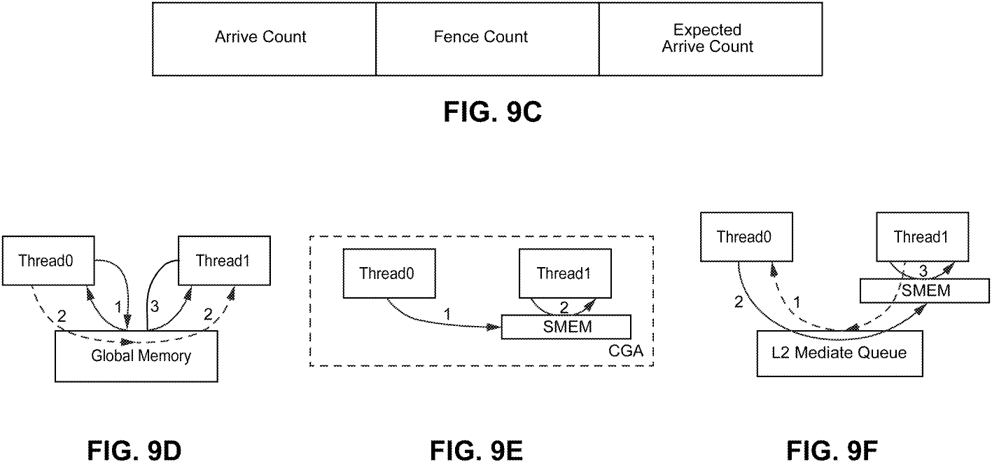

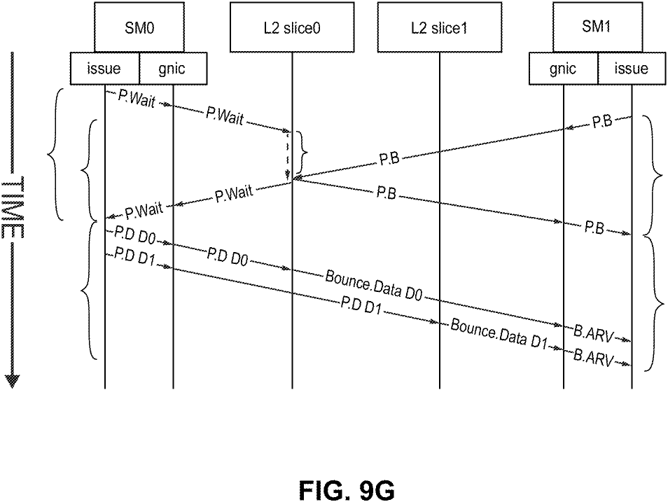

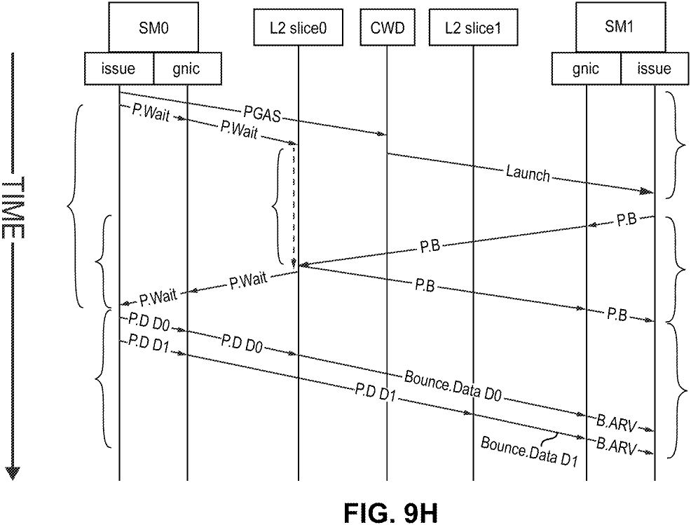

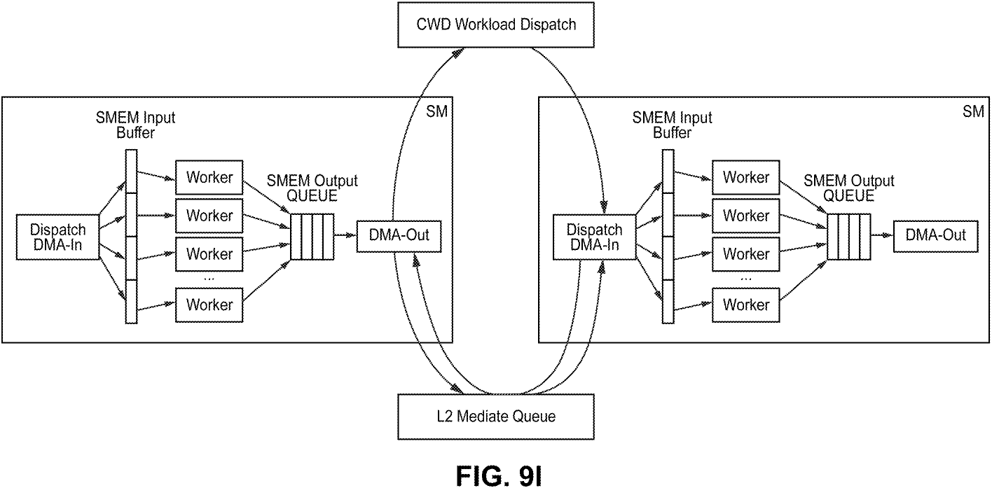

FIG. 9A shows an example conceptual view of a fence instruction from the source SM being replicated into four separate fence messages for the same barrier “BarS” and being transmitted from the source SM to the destination SM via all four available paths through an interconnect in an implementation in which the four paths are the only paths on which messages from the source SM can reach the destination SM. As illustrated the corresponding arrive message may have taken any one of the four paths. An example barrier, such as barrier BarS, to which the messages in FIG. 9A are directed, is shown in FIG. 9C with at least the fields of an arrive count, expected arrive count, and fence count.

The fence instructions, because of their replication to all paths between the source and destination, may generate substantial additional traffic on the interconnect. For example, for each fence packet generated by the source thread, the memory system may replicate N fence packets to transmit over each of the N available paths to the destination SM. In some embodiments the interconnect bandwidth is configured to limit the bandwidth available for the SM2SM traffic such as the fence messages so that the reduction of the interconnect bandwidth available to L2 data and L2-related messaging is minimized. Thus, example embodiments, may restrict SM2SM traffic on the interconnect (e.g. crossbar) to a subset of the links available on the interconnect, and may distribute the SM2SM traffic over the subset so that the reduction of bandwidth available for L2 on the interconnect is controlled. FIG. 9B, for example, illustrates that a subset of four links each carry 25% of the SM2DM traffic.

FIGS. 9D-9F illustrate three different data exchange models. FIG. 9D illustrates the conventional global memory based data exchange, with synchronization latency of 3 to 4 roundtrips to L2 cache. FIG. 9E illustrates the shared memory based SM2SM data exchange that operates in the GPC-CGA scope (CGA-scope extending to GPC), with synchronization latency about 0.5 roundtrip, according to some embodiments. FIG. 9F shows a L2-mediated SM2SM data exchange model in which synchronization latency is around two L2 roundtrips. It should be noted that the latency for 9F includes the buffer-availability synchronization while FIGS. 9D and 9E do not.

In the model of FIG. 9D, the communication is more similar to shared memory-based SM2SM data exchange even though the data transfer is routed through L2. The flow may operate as described next.

An entity in an L2 slice, which may be referred to as an agent and which may be well-known to processors in the system, is defined to mediate the exchange between producer and consumer processes. A respective agent may be defined for each specific type of communication, and may include a queue that coordinates the communication and permits some level of pipelining. Instead of a data queue that a producer thread pushes into, the agent can include a consumer queue upon which the consumer waits for data. Hardware support can provide for such a queue to reside in a single L2 slice.

The consumer thread sets up a local shared memory buffer as the receiving buffer, a transaction barrier, and a data receiving remap table. The consumer pushes receiving data into the queue. Push fails due to the queue being full, may require retry. When the queue is non-empty, the producer thread can push its data through L2 slices, where the agent operates to reflect the data into the consumer’s receive buffer. The data push may target a specific L2 slice and be bounced back to consumer like a load data.

The L2 slice of choice may be determined through a hash or the like aiming to spread out to different slices more evenly. Data packets are tagged with the consumer information posted in the queue, together with buffer internal offset managed by producer. The time chart in FIG. 9G illustrates the events in this exchange model.

FIG. 9G shows SOL latency for L2-mediated SM2SM data exchange, according to an embodiment. The L2 slice0 includes a hardware-supported queue structure that may, in some embodiments, reside only on a single L2 slice. The producer processor (SM0) first performs a queue PopWait operation with extra wait latency to setup the exchange of data. This operation, between sending and returning of PopWait (“P.Wait”), incurs 1 roundtrip. The consumer processor (SM1) publishes the receiving buffer to L2 slice0 and issues a queue PushBuf (“P.B”) operation. If the queue is full, the consumer may retry. Upon the PopWait returning, the producer pushes data through the L2 slices. In the illustrated example, D0 is pushed to L2 slice0 and bounced to the consumer. D1 is pushed to L2 slice1 and bounced to the consumer. From the consumer viewpoint, due to the data being bounced from the respective L2 slices to the consumer’s local memory, the data exchange incurs one roundtrip or less.

Comparing the mediated model of FIG. 9F against the conventional global memory-based data exchange of FIG. 9D several characteristics can be observed: the mediated communication is more closely coupled; it does not stage data in global memory buffer, but directly stores into the destination CTA’s shared memory; it requires both producer and consumer to exist in the GPU for the communication to happen; and it is in the form of a SOL SM2SM synchronization that may extend beyond the GPC_CGA scope.

The data communication in the embodiment of FIG. 9D may not need to be explicitly fenced. However, in some embodiments it may use any object fence mechanism and semantics.

When the transaction barrier in the consumer clears, the data updates from the producers to the associated shared memory buffer is guaranteed visible. The minimal latency between consumer push and data arrival is around two L2 roundtrips. The first roundtrip to communicate the “buffer ready information” (“P.B” in FIG. 9F) from consumer. The second roundtrip time is an approximation of the latency from the transmission of the data (e.g., PushData (“P.D”) in FIG. 9F) by the producer processor (SM0) to reach L2, then to be bounced in the L2 to the consumer thread (SM1) to communicate the data itself, and subsequently generating an arrive operation to update the barrier at the consumer processor. The PushData operation may have obtained the address of the receive buffer from the buffer information pushed on the queue by the consumer. Although not shown in the figure, in some embodiments, the data may be staged in the shared memory before being used by the consumer process. Staging the data in shared memory provides an opportunity for organizing the incoming data (e.g., data swizzle and minimize data divergence) for more efficient processing by the consumer process.

Hardware support may include hardware-supported mediating queues in L2. Each queue may carry the following information: the block size of the transfer, and the number of blocks and routing information (e.g., consumer SM ID or crossbar node / port ID) in each entry. In an example implementation, a queue may fit on a single L2 slice and may be memory backed. In an example implementation, a single 256B queue can fit on a single slice, can support up to 63 entries with 4B entry size, or 126 entries with 2B entry size. In case a larger queue is desired, special address hash / space and global memory carve out for a backing-store may be used.

The hardware may support atomic queue operations: PushBuf and Popwait. PushBuf can be used to advertise data receiving buffer by pushing into the tail of the queue, return if the push is successful immediately. PopWait can be used to wait if pending block counter indicates not enough buffer to produce, or reserve the pending block counter otherwise. A separated try-wait buffer to hold the waiting producer may also be provided.

The hardware may further provide split SM2SM support. Consumer-side data receiving buffer setup may include allocating shared memory buffer, initializing transaction barrier, setting up buffer base / size / barrier etc. into a remap table, and performing PushBuf and cancelling the setting up of the buffer on fail. Producer side data pushing may include special store flavor that will bounce to destination SM like a load, special tex2gnic packet type with routing info returned from PopWait, optionally multicast store for queue expansion. Since the barrier is on the consumer side and is not made visible to producer, the consumer may have the responsibility to setup the expected transaction count. Either set the precise number if the size is well-known between the producer and consumer. When the data packet size can vary, set the maximum number that matches the buffer size, and the producer has the responsibility to close the exchange when the data is actually smaller.

FIG. 9H shows a flowchart of SOL latency for L2-mediated SM2SM communication in a compute queue model implementation. In the implementation shown in FIG. 9H, a different resource management model from the model of FIG. 9G is used. Like in the implementation of FIG. 9G, a hardware-supported queue structure that resides in an L2 slice exists. Each producer only sees a temporal local queue in shared memory. The temporal queue covers the latency to coalesce workload and get consumer ready.

The producer, through a persistent agent in global memory, launches the consumer as needed by causing the persistent agent to issue a launch a consumer thread to receive the data that the producer is yet to produce. By providing for the persistent agent to control the startup of the consumer process, the producer retires and releases register file resource for consumer as it dumps data into a local queue. The persistent agent (“CWD Workload Dispatch” in FIG. 9I) handles the local queue for the worker warps. Similarly the same persistent agent for consumer side setup to avoid cold misses on newly launched CTA

A conceptual system diagram for the operations in FIG. 9H is shown in FIG. 9I with the producer being shown on the right and the consumer on the left. Direct memory access (DMA) units of the producer and consumer, controlled by a persistent agent “CWD workload dispatch”, moves data from the output queue in the producer’s local shared memory via the L2-mediated queue(s) to the input buffers in the local shared memory of the consumer. In the producer, worker threads populate the output queue with data from an input buffer. In the consumer, worker threads move the received data from the input buffers to a shared memory input queue for use by the consumer processes.

### Example GPU Architecture

An example illustrative architecture in which the fast data synchronization disclosed in this application is incorporated will now be described. The following information is set forth for illustrative purposes and should not be construed as limiting in any manner. Any of the following features may be optionally incorporated with or without the exclusion of other features described.

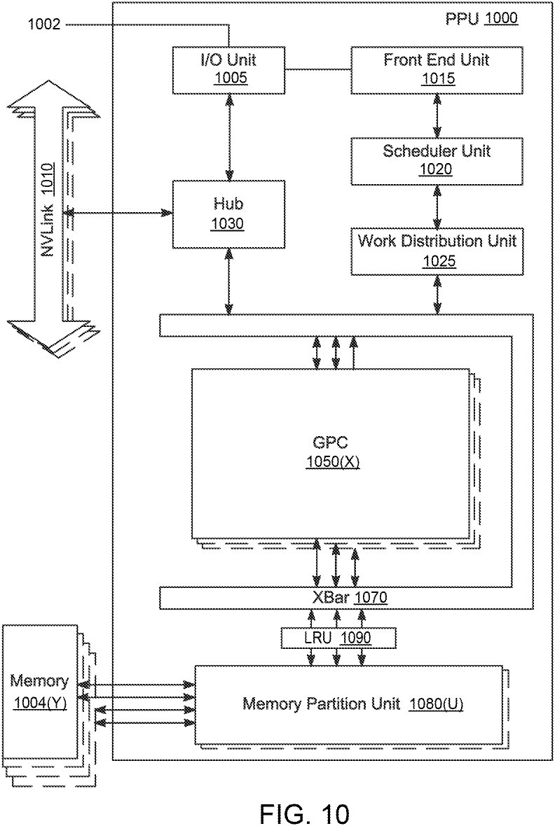

FIG. 10 illustrates a parallel processing unit (PPU) 1000, in accordance with an embodiment. In an embodiment, the PPU 1000 is a multi-threaded processor that is implemented on one or more integrated circuit devices. The PPU 1000 is a latency hiding architecture designed to process many threads in parallel. A thread (e.g., a thread of execution) is an instantiation of a set of instructions configured to be executed by the PPU 1000. In an embodiment, the PPU 1000 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 1000 may be utilized for performing general-purpose computations. In some other embodiments, PPU 100 configured to implement large neural networks in deep learning applications or other high performance computing applications.

One or more PPUs 1000 may be configured to accelerate thousands of High Performance Computing (HPC), data center, and machine learning applications. The PPU 1000 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 10, the PPU 1000 includes an Input/Output (I/O) unit 1005, a front end unit 1015, a scheduler unit 1020, a work distribution unit 1025, a hub 1030, a crossbar (Xbar) 1070, one or more general processing clusters (GPCs) 1050, and one or more partition units 1080. An LRC 1080, such as, for example, described above in relation to FIGS. 2 and 2A, may be located between crossbar 1070 and the MPU 1080, and may be configured to support the multicast described above. The PPU 1000 may be connected to a host processor or other PPUs 1000 via one or more high-speed NVLink 1010 interconnect. The PPU 1000 may be connected to a host processor or other peripheral devices via an interconnect 1002. The PPU 1000 may also be connected to a memory comprising a number of memory devices 1004. In an embodiment, the memory 1004 may comprise a number of dynamic random access memory (DRAM) devices. The DRAM devices may be configured as a high-bandwidth memory (HBM) subsystem, with multiple DRAM dies stacked within each device.

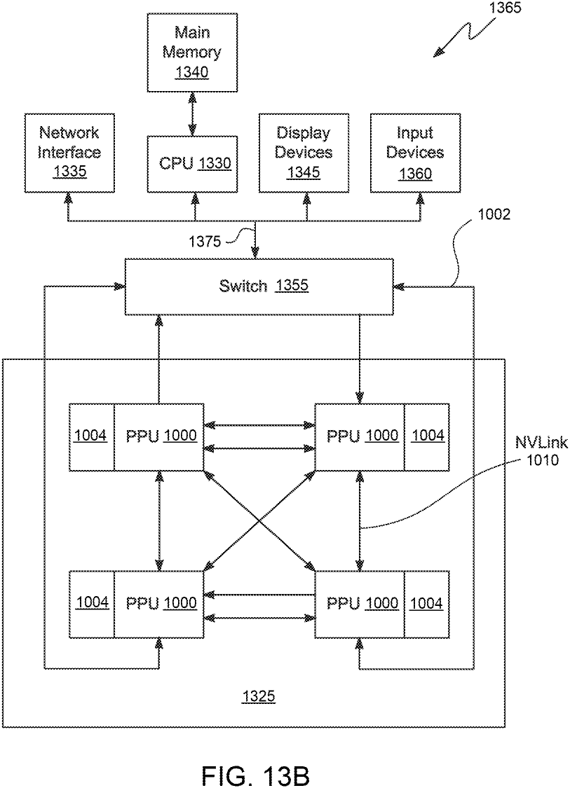

The NVLink 1010 interconnect enables systems to scale and include one or more PPUs 1000 combined with one or more CPUs, supports cache coherence between the PPUs 1000 and CPUs, and CPU mastering. Data and/or commands may be transmitted by the NVLink 1010 through the hub 1030 to/from other units of the PPU 1000 such as one or more copy engines, a video encoder, a video decoder, a power management unit, etc. (not explicitly shown). The NVLink 1010 is described in more detail in conjunction with FIG. 13A and FIG. 13B.

The I/O unit 1005 is configured to transmit and receive communications (e.g., commands, data, etc.) from a host processor (not shown) over the interconnect 1002. The I/O unit 1005 may communicate with the host processor directly via the interconnect 1002 or through one or more intermediate devices such as a memory bridge. In an embodiment, the I/O unit 1005 may communicate with one or more other processors, such as one or more of the PPUs 1000 via the interconnect 1002. In an embodiment, the I/O unit 1005 implements a Peripheral Component Interconnect Express (PCIe) interface for communications over a PCIe bus and the interconnect 1002 is a PCIe bus. In alternative embodiments, the I/O unit 1005 may implement other types of well-known interfaces for communicating with external devices.

The I/O unit 1005 decodes packets received via the interconnect 1002. In an embodiment, the packets represent commands configured to cause the PPU 1000 to perform various operations. The I/O unit 1005 transmits the decoded commands to various other units of the PPU 1000 as the commands may specify. For example, some commands may be transmitted to the front end unit 1015. Other commands may be transmitted to the hub 1030 or other units of the PPU 1000 such as one or more copy engines, a video encoder, a video decoder, a power management unit, etc. (not explicitly shown). In other words, the I/O unit 1005 is configured to route communications between and among the various logical units of the PPU 1000.

In an embodiment, a program executed by the host processor encodes a command stream in a buffer that provides workloads to the PPU 1000 for processing. A workload may comprise several instructions and data to be processed by those instructions. The buffer is a region in a memory that is accessible (e.g., read/write) by both the host processor and the PPU 1000. For example, the I/O unit 1005 may be configured to access the buffer in a system memory connected to the interconnect 1002 via memory requests transmitted over the interconnect 1002. In an embodiment, the host processor writes the command stream to the buffer and then transmits a pointer to the start of the command stream to the PPU 1000. The front end unit 1015 receives pointers to one or more command streams. The front end unit 1015 manages the one or more streams, reading commands from the streams and forwarding commands to the various units of the PPU 1000.

The front end unit 1015 is coupled to a scheduler unit 1020 that configures the various GPCs 1050 to process tasks defined by the one or more streams. The scheduler unit 1020 is configured to track state information related to the various tasks managed by the scheduler unit 1020. The state may indicate which GPC 1050 a task is assigned to, whether the task is active or inactive, a priority level associated with the task, and so forth. The scheduler unit 1020 manages the execution of a plurality of tasks on the one or more GPCs 1050.

The scheduler unit 1020 is coupled to a work distribution unit 1025 that is configured to dispatch tasks for execution on the GPCs 1050. The work distribution unit 1025 may track a number of scheduled tasks received from the scheduler unit 1020. In an embodiment, the work distribution unit 1025 manages a pending task pool and an active task pool for each of the GPCs 1050. The pending task pool may comprise a number of slots (e.g., 32 slots) that contain tasks assigned to be processed by a particular GPC 1050. The active task pool may comprise a number of slots (e.g., 4 slots) for tasks that are actively being processed by the GPCs 1050. As a GPC 1050 finishes the execution of a task, that task is evicted from the active task pool for the GPC 1050 and one of the other tasks from the pending task pool is selected and scheduled for execution on the GPC 1050. If an active task has been idle on the GPC 1050, such as while waiting for a data dependency to be resolved, then the active task may be evicted from the GPC 1050 and returned to the pending task pool while another task in the pending task pool is selected and scheduled for execution on the GPC 1050.

The work distribution unit 1025 communicates with the one or more GPCs 1050 via XBar 1070. The XBar 1070 is an interconnect network that couples many of the units of the PPU 1000 to other units of the PPU 1000. For example, the XBar 1070 may be configured to couple the work distribution unit 1025 to a particular GPC 1050. Although not shown explicitly, one or more other units of the PPU 1000 may also be connected to the XBar 1070 via the hub 1030.

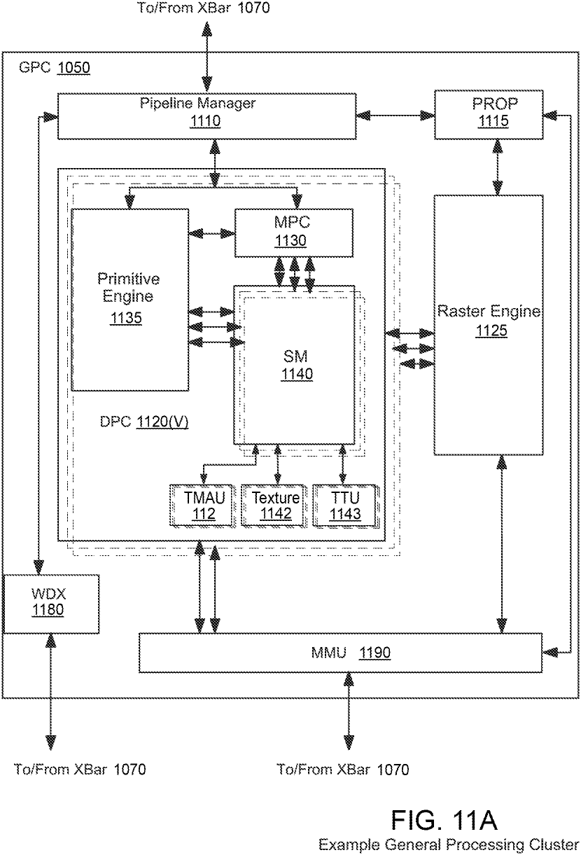

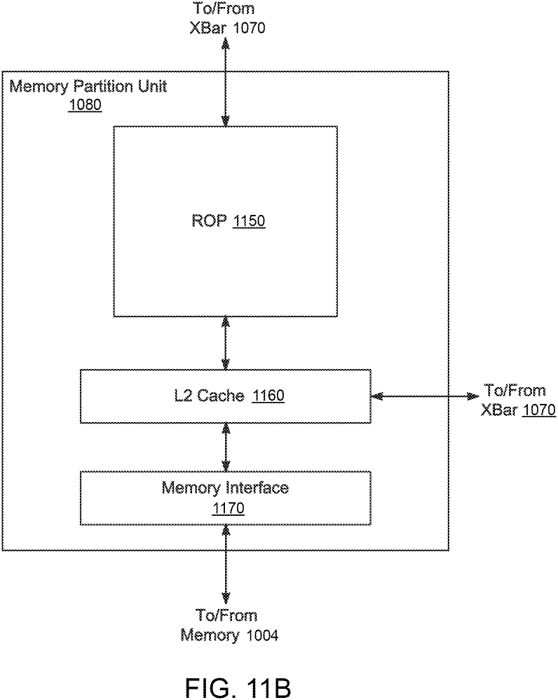

The tasks are managed by the scheduler unit 1020 and dispatched to a GPC 1050 by the work distribution unit 1025. The GPC 1050 is configured to process the task and generate results. The results may be consumed by other tasks within the GPC 1050, routed to a different GPC 1050 via the XBar 1070, or stored in the memory 1004. The results can be written to the memory 1004 via the partition units 1080, which implement a memory interface for reading and writing data to/from the memory 1004. The results can be transmitted to another PPU 1004 or CPU via the NVLink 1010. In an embodiment, the PPU 1000 includes a number U of partition units 1080 that is equal to the number of separate and distinct memory devices 1004 coupled to the PPU 1000. A partition unit 1080 will be described in more detail below in conjunction with FIG. 11B.

In an embodiment, a host processor executes a driver kernel that implements an application programming interface (API) that enables one or more applications executing on the host processor to schedule operations for execution on the PPU 1000. In an embodiment, multiple compute applications are simultaneously executed by the PPU 1000 and the PPU 1000 provides isolation, quality of service (QoS), and independent address spaces for the multiple compute applications. An application may generate instructions (e.g., API calls) that cause the driver kernel to generate one or more tasks for execution by the PPU 1000. The driver kernel outputs tasks to one or more streams being processed by the PPU 1000. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads, cooperating threads and a hierarchical grouping of threads such as cooperating thread arrays (CTA) and cooperating group arrays (CGA) according to some embodiments are described in more detail in U.S. Application No. 17/691,621, the entire content of which is hereby incorporated by reference in its entirety.

FIG. 11A illustrates a GPC 1050 of the PPU 1000 of FIG. 10, in accordance with an embodiment. As shown in FIG. 11A, each GPC 1050 includes a number of hardware units for processing tasks. In an embodiment, each GPC 1050 includes a pipeline manager 1110, a pre-raster operations unit (PROP) 1115, a raster engine 1125, a work distribution crossbar (WDX) 1180, a memory management unit (MMU) 1190, and one or more Data Processing Clusters (DPCs) 1120. It will be appreciated that the GPC 1050 of FIG. 11A may include other hardware units in lieu of or in addition to the units shown in FIG. 11A.

In an embodiment, the operation of the GPC 1050 is controlled by the pipeline manager 1110. The pipeline manager 1110 manages the configuration of the one or more DPCs 1120 for processing tasks allocated to the GPC 1050. In an embodiment, the pipeline manager 1110 may configure at least one of the one or more DPCs 1120 to implement at least a portion of a graphics rendering pipeline, a neural network, and/or a compute pipeline. For example, with respect to a graphics rendering pipeline, a DPC 1120 may be configured to execute a vertex shader program on the programmable streaming multiprocessor (SM) 1140. The pipeline manager 1110 may also be configured to route packets received from the work distribution unit 1025 to the appropriate logical units within the GPC 1050. For example, some packets may be routed to fixed function hardware units in the PROP 1115 and/or raster engine 1125 while other packets may be routed to the DPCs 1120 for processing by the primitive engine 1135 or the SM 1140.

The PROP unit 1115 is configured to route data generated by the raster engine 1125 and the DPCs 1120 to a Raster Operations (ROP) unit, described in more detail in conjunction with FIG. 11B. The PROP unit 1115 may also be configured to perform optimizations for color blending, organize pixel data, perform address translations, and the like.

Each DPC 1120 included in the GPC 1050 includes an M-Pipe Controller (MPC) 1130, a primitive engine 1135, and one or more SMs 1140. The MPC 1130 controls the operation of the DPC 1120, routing packets received from the pipeline manager 1110 to the appropriate units in the DPC 1120. For example, packets associated with a vertex may be routed to the primitive engine 1135, which is configured to fetch vertex attributes associated with the vertex from the memory 1004. In contrast, packets associated with a shader program may be transmitted to the SM 1140.

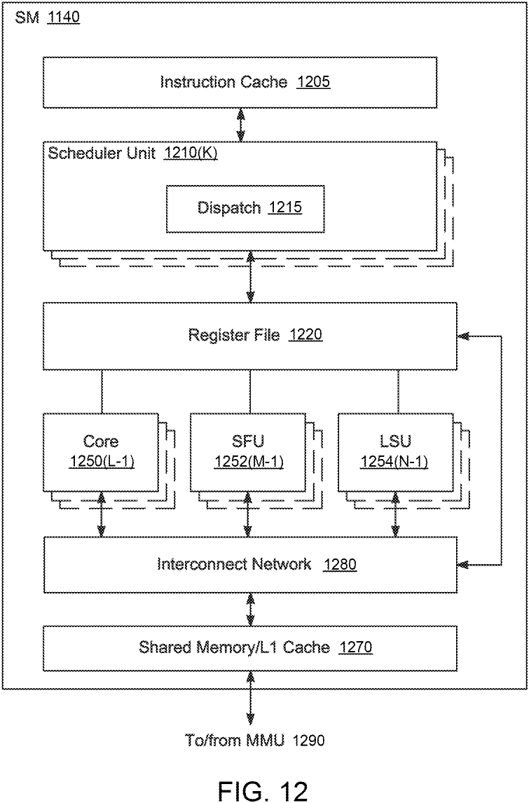

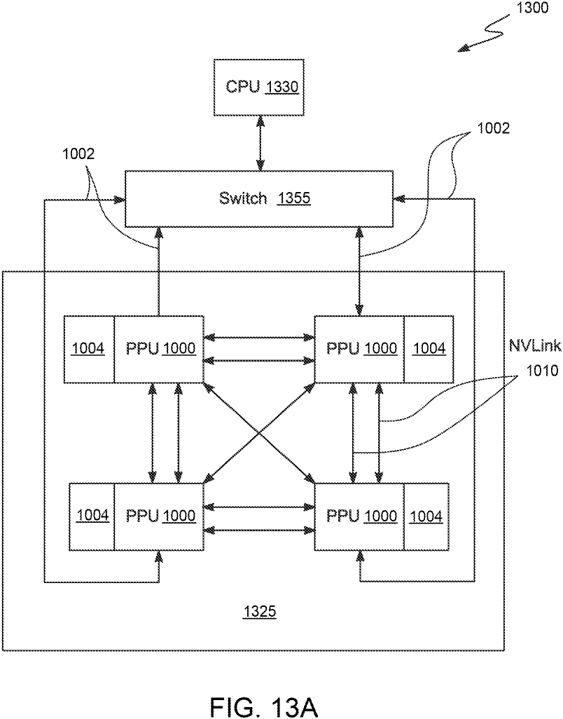

The SM 1140 comprises a programmable streaming processor that is configured to process tasks represented by a number of threads. Each SM 1140 is multi-threaded and configured to execute a plurality of threads (e.g., 32 threads) from a particular group of threads concurrently. In an embodiment, the SM 1140 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 1140 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 1140 is described in more detail below in conjunction with FIG. 12A.

The MMU 1190 provides an interface between the GPC 1050 and the partition unit 1080. The MMU 1190 may provide translation of virtual addresses into physical addresses, memory protection, and arbitration of memory requests. In an embodiment, the MMU 1190 provides one or more translation lookaside buffers (TLBs) for performing translation of virtual addresses into physical addresses in the memory 1004.

FIG. 11B illustrates a memory partition unit 1080 of the PPU 1000 of FIG. 10 in accordance with an embodiment. As shown in FIG. 11B, the memory partition unit 1080 includes a Raster Operations (ROP) unit 1150, a level two (L2) cache 1160, and a memory interface 1170. The memory interface 1170 is coupled to the memory 1004. Memory interface 1170 may implement 32, 64, 128, 1024-bit data buses, or the like, for high-speed data transfer. In an embodiment, the PPU 1000 incorporates U memory interfaces 1170, one memory interface 1170 per pair of partition units 1080, where each pair of partition units 1080 is connected to a corresponding memory device 1004. For example, PPU 1000 may be connected to up to Y memory devices 1004, such as high bandwidth memory stacks or graphics double-data-rate, version 5, synchronous dynamic random access memory, or other types of persistent storage.

In an embodiment, the memory interface 1170 implements an HBM2 memory interface and Y equals half U. In an embodiment, the HBM2 memory stacks are located on the same physical package as the PPU 1000, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1004 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 1000 process very large datasets and/or run applications for extended periods.

In an embodiment, the PPU 1000 implements a multi-level memory hierarchy. In an embodiment, the memory partition unit 1080 supports a unified memory to provide a single unified virtual address space for CPU and PPU 300 memory, enabling data sharing between virtual memory systems. In an embodiment the frequency of accesses by a PPU 1000 to memory located on other processors is traced to ensure that memory pages are moved to the physical memory of the PPU 1000 that is accessing the pages more frequently. In an embodiment, the NVLink 1010 supports address translation services allowing the PPU 1000 to directly access a CPU’s page tables and providing full access to CPU memory by the PPU 1000.

In an embodiment, copy engines transfer data between multiple PPUs 1000 or between PPUs 1000 and CPUs. The copy engines can generate page faults for addresses that are not mapped into the page tables. The memory partition unit 1080 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1004 or other system memory may be fetched by the memory partition unit 1080 and stored in the L2 cache 1160, which is located on-chip and is shared between the various GPCs 1050. As shown, each memory partition unit 1080 includes a portion of the L2 cache 1160 associated with a corresponding memory device 1004. Lower level caches may then be implemented in various units within the GPCs 1050. For example, each of the SMs 1140 may implement a level one (L1) cache. The L1 cache is private memory that is dedicated to a particular SM 1140. Data from the L2 cache 1160 may be fetched and stored in each of the L1 caches for processing in the functional units of the SMs 1140. The L2 cache 1160 is coupled to the memory interface 1170 and the XBar 1070.

The ROP unit 1150 performs graphics raster operations related to pixel color, such as color compression, pixel blending, and the like. The ROP unit 450 also implements depth testing in conjunction with the raster engine 1125, receiving a depth for a sample location associated with a pixel fragment from the culling engine of the raster engine 1125. The depth is tested against a corresponding depth in a depth buffer for a sample location associated with the fragment. If the fragment passes the depth test for the sample location, then the ROP unit 1150 updates the depth buffer and transmits a result of the depth test to the raster engine 1125. It will be appreciated that the number of partition units 1080 may be different than the number of GPCs 1050 and, therefore, each ROP unit 1150 may be coupled to each of the GPCs 1050. The ROP unit 1150 tracks packets received from the different GPCs 1050 and determines which GPC 1050 that a result generated by the ROP unit 1150 is routed to through the Xbar 1070. Although the ROP unit 1150 is included within the memory partition unit 1080 in FIG. 11B, in other embodiment, the ROP unit 1150 may be outside of the memory partition unit 1080. For example, the ROP unit 1150 may reside in the GPC 1050 or another unit.

FIG. 12 illustrates the streaming multiprocessor 1140 of FIG. 11A, in accordance with an embodiment. As shown in FIG. 12, the SM 1140 includes an instruction cache 1205, one or more scheduler units 1210, a register file 1220, one or more processing cores 1250, one or more special function units (SFUs) 1252, one or more load/store units (LSUs) 1254, an interconnect network 1280, a shared memory/L1 cache 1270.

As described above, the work distribution unit 1025 dispatches tasks for execution on the GPCs 1050 of the PPU 1000. The tasks are allocated to a particular DPC 1120 within a GPC 1050 and, if the task is associated with a shader program, the task may be allocated to an SM 1140. The scheduler unit 1210 receives the tasks from the work distribution unit 1025 and manages instruction scheduling for one or more thread blocks assigned to the SM 1140. The scheduler unit 1210 schedules thread blocks for execution as warps of parallel threads, where each thread block is allocated at least one warp. In an embodiment, each warp executes 32 threads. The scheduler unit 1210 may manage a plurality of different thread blocks, allocating the warps to the different thread blocks and then dispatching instructions from the plurality of different cooperative groups to the various functional units (e.g., cores 1250, SFUs 1252, and LSUs 1254) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads() function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks. Hierarchical grouping of threads such as cooperating thread arrays (CTA) and cooperating group arrays (CGA) according to some embodiments are described in more detail in U.S. Application No. 17/691,621, the entire content of which is hereby incorporated by reference in its entirety.

A dispatch unit 1215 is configured to transmit instructions to one or more of the functional units. In the embodiment, the scheduler unit 1210 includes two dispatch units 1215 that enable two different instructions from the same warp to be dispatched during each clock cycle. In alternative embodiments, each scheduler unit 1210 may include a single dispatch unit 1215 or additional dispatch units 1215.

Each SM 1140 includes a register file 1220 that provides a set of registers for the functional units of the SM 1140. In an embodiment, the register file 1220 is divided between each of the functional units such that each functional unit is allocated a dedicated portion of the register file 1220. In another embodiment, the register file 1220 is divided between the different warps being executed by the SM 1140. The register file 1220 provides temporary storage for operands connected to the data paths of the functional units.

Each SM 1140 comprises multiple processing cores 1250. In an embodiment, the SM 1140 includes a large number (e.g., 128, etc.) of distinct processing cores 1250. Each core 1250 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 1250 include 64 single-precision (32-bit) floating point cores, 64 integer cores, 32 double-precision (64-bit) floating point cores, and 8 tensor cores.

Tensor cores are configured to perform matrix operations, and, in an embodiment, one or more tensor cores are included in the cores 1250. In particular, the tensor cores are configured to perform deep learning matrix arithmetic, such as convolution operations for neural network training and inferencing. In an embodiment, each tensor core operates on a 4x4 matrix and performs a matrix multiply and accumulate operation D=AxB+C, where A, B, C, and D are 4x4 matrices.

In an embodiment, the matrix multiply inputs A and B are 16-bit floating point matrices, while the accumulation matrices C and D may be 16-bit floating point or 32-bit floating point matrices. Tensor cores operate on 16-bit floating point input data with 32-bit floating point accumulation. The 16-bit floating point multiply requires 64 operations and results in a full precision product that is then accumulated using 32-bit floating point addition with the other intermediate products for a 4x4x4 matrix multiply. In practice, Tensor cores are used to perform much larger two-dimensional or higher dimensional matrix operations, built up from these smaller elements. An API, such as CUDA C++ API, exposes specialized matrix load, matrix multiply and accumulate, and matrix store operations to efficiently use Tensor cores from a CUDA-C++ program. At the CUDA level, the warp-level interface assumes 16x16 size matrices spanning all 32 threads of the warp.

In some embodiments, transposition hardware is included in the processing cores 1250 or another functional unit (e.g., SFUs 1252 or LSUs 1254) and is configured to generate matrix data stored by diagonals and/or generate the original matrix and/or transposed matrix from the matrix data stored by diagonals. The transposition hardware may be provide inside of the shared memory 1270 to register file 1220 load path of the SM 1140.

In one example, the matrix data stored by diagonals may be fetched from DRAM and stored in the shared memory 1270. As the instruction to perform processing using the matrix data stored by diagonals is processed, transposition hardware disposed in the path of the shared memory 1270 and the register file 1220 may provide the original matrix, transposed matrix, compacted original matrix, and/or compacted transposed matrix. Up until the very last storage prior to instruction, the single matrix data stored by diagonals may be maintained, and the matrix type designated by the instruction is generated as needed in the register file 1220.

Each SM 1140 also comprises multiple SFUs 1252 that perform special functions (e.g., attribute evaluation, reciprocal square root, and the like). In an embodiment, the SFUs 1252 may include a tree traversal unit (e.g., TTU 1143) configured to traverse a hierarchical tree data structure. In an embodiment, the SFUs 1252 may include texture unit (e.g., Texture Unit 1142) configured to perform texture map filtering operations. In an embodiment, the texture units are configured to load texture maps (e.g., a 2D array of texels) from the memory 1004 and sample the texture maps to produce sampled texture values for use in shader programs executed by the SM 1140. In an embodiment, the texture maps are stored in the shared memory/L1 cache 1170. The texture units implement texture operations such as filtering operations using mip-maps (e.g., texture maps of varying levels of detail). In an embodiment, each SM 1140 includes two texture units.

Each SM 1140 also comprises multiple LSUs 1254 that implement load and store operations between the shared memory/L1 cache 1270 and the register file 1220. Each SM 1140 includes an interconnect network 1280 that connects each of the functional units to the register file 1220 and the LSU 1254 to the register file 1220, shared memory/ L1 cache 1270. In an embodiment, the interconnect network 1280 is a crossbar that can be configured to connect any of the functional units to any of the registers in the register file 1220 and connect the LSUs 1254 to the register file 1220 and memory locations in shared memory/L1 cache 1270.

The shared memory/L1 cache 1270 is an array of on-chip memory that allows for data storage and communication between the SM 1140 and the primitive engine 1135 and between threads in the SM 1140. In an embodiment, the shared memory/L1 cache 1270 comprises 128KB of storage capacity and is in the path from the SM 1140 to the partition unit 1080. The shared memory/L1 cache 1270 can be used to cache reads and writes. One or more of the shared memory/L1 cache 1270, L2 cache 1160, and memory 1004 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1270 enables the shared memory/L1 cache 1270 to function as a high-throughput conduit for streaming data while simultaneously providing high-bandwidth and low-latency access to frequently reused data.

In the context of this disclosure, an SM or “streaming multiprocessor” means a processor architected as described in USP7,447,873 to Nordquist including improvements thereto and advancements thereof, and as implemented for example in many generations of NVIDIA GPUs. For example, an SM may comprise a plurality of processing engines or cores configured to concurrently execute a plurality of threads arranged in a plurality of single-instruction, multiple-data (SIMD) groups (e.g., warps), wherein each of the threads in a same one of the SIMD groups executes a same data processing program comprising a sequence of instructions on a different input object, and different threads in the same one of the SIMD group are executed using different ones of the processing engines or cores. An SM may typically also provide (a) a local register file having plural lanes, wherein each processing engine or core is configured to access a different subset of the lanes; and instruction issue logic configured to select one of the SIMD groups and to issue one of the instructions of the same data processing program to each of the plurality of processing engines in parallel, wherein each processing engine executes the same instruction in parallel with each other processing engine using the subset of the local register file lanes accessible thereto. An SM typically further includes core interface logic configured to initiate execution of one or more SIMD groups. As shown in the figures, such SMs have been constructed to provide fast local shared memory enabling data sharing/reuse and synchronization between all threads of a CTA executing on the SM.

When configured for general purpose parallel computation, a simpler configuration can be used compared with graphics processing. Specifically, the fixed function graphics processing units shown in FIG. 11A, are bypassed, creating a much simpler programming model. In the general purpose parallel computation configuration, the work distribution unit 1025 assigns and distributes blocks of threads directly to the DPCs 1120. The threads in a block execute the same program, using a unique thread ID in the calculation to ensure each thread generates unique results, using the SM 1140 to execute the program and perform calculations, shared memory/L1 cache 1270 to communicate between threads, and the LSU 1254 to read and write global memory through the shared memory/L1 cache 1270 and the memory partition unit 1080. When configured for general purpose parallel computation, the SM 1140 can also write commands that the scheduler unit 1020 can use to launch new work on the DPCs 1120.

The PPU 1000 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 1000 is embodied on a single semiconductor substrate. In another embodiment, the PPU 1000 is included in a system-on-a-chip (SoC) along with one or more other devices such as additional PPUs 1000, the memory 1004, a reduced instruction set computer (RISC) CPU, a memory management unit (MMU), a digital-to-analog converter (DAC), and the like.

In an embodiment, the PPU 1000 may be included on a graphics card that includes one or more memory devices 1004. The graphics card may be configured to interface with a PCIe slot on a motherboard of a desktop computer. In yet another embodiment, the PPU 1000 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13A is a conceptual diagram of a processing system 1300 implemented using the PPU 1000 of FIG. 10, in accordance with an embodiment. The exemplary system 1300 may be configured to implement the methods disclosed in this application (e.g., the TMAU in FIGS. 1, 2, 6 or 11A). The processing system 1300 includes a CPU 1330, switch 1355, and multiple PPUs 1000 each and respective memories 1004. The NVLink 1010 provides high-speed communication links between each of the PPUs 1000. Although a particular number of NVLink 1010 and interconnect 1002 connections are illustrated in FIG. 13A, the number of connections to each PPU 1000 and the CPU 1330 may vary. The switch 1355 interfaces between the interconnect 1002 and the CPU 1330. The PPUs 1000, memories 1004, and NVLinks 1010 may be situated on a single semiconductor platform to form a parallel processing module 1325. In an embodiment, the switch 1355 supports two or more protocols to interface between various different connections and/or links.

In another embodiment (not shown), the NVLink 1010 provides one or more high-speed communication links between each of the PPUs 1000 and the CPU 1330 and the switch 1355 interfaces between the interconnect 1002 and each of the PPUs 1000. The PPUs 1000, memories 1004, and interconnect 1002 may be situated on a single semiconductor platform to form a parallel processing module 1325. In yet another embodiment (not shown), the interconnect 1002 provides one or more communication links between each of the PPUs 1000 and the CPU 1330 and the switch 1355 interfaces between each of the PPUs 1000 using the NVLink 1010 to provide one or more high-speed communication links between the PPUs 1000. In another embodiment (not shown), the NVLink 1010 provides one or more high-speed communication links between the PPUs 1000 and the CPU 1330 through the switch 1355. In yet another embodiment (not shown), the interconnect 1002 provides one or more communication links between each of the PPUs 1000 directly. One or more of the NVLink 1010 high-speed communication links may be implemented as a physical NVLink interconnect or either an on-chip or on-die interconnect using the same protocol as the NVLink 1010.

In the context of the present description, a single semiconductor platform may refer to a sole unitary semiconductor-based integrated circuit fabricated on a die or chip. It should be noted that the term single semiconductor platform may also refer to multichip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1325 may be implemented as a circuit board substrate and each of the PPUs 1000 and/or memories 1004 may be packaged devices. In an embodiment, the CPU 1330, switch 1355, and the parallel processing module 1325 are situated on a single semiconductor platform.

In an embodiment, the signaling rate of each NVLink 1010 is 20 to 25 Gigabits/second and each PPU 1000 includes six NVLink 1010 interfaces (as shown in FIG. 13A, five NVLink 1010 interfaces are included for each PPU 1000). Each NVLink 1010 provides a data transfer rate of 25 Gigabytes/second in each direction, with six links providing 1000 Gigabytes/second. The NVLinks 1010 can be used exclusively for PPU-to-PPU communication as shown in FIG. 13A, or some combination of PPU-to-PPU and PPU-to-CPU, when the CPU 1330 also includes one or more NVLink 1010 interfaces.

In an embodiment, the NVLink 1010 allows direct load/store/atomic access from the CPU 1330 to each PPU’s 1000 memory 1004. In an embodiment, the NVLink 1010 supports coherency operations, allowing data read from the memories 1004 to be stored in the cache hierarchy of the CPU 1330, reducing cache access latency for the CPU 1330. In an embodiment, the NVLink 1010 includes support for Address Translation Services (ATS), allowing the PPU 1000 to directly access page tables within the CPU 1330. One or more of the NVLinks 1010 may also be configured to operate in a low-power mode.

FIG. 13B illustrates an exemplary system 1365 in which the various architecture and/or functionality of the various previous embodiments may be implemented. The exemplary system 1365 may be configured to implement the methods disclosed in this application (e.g., the TMAU in FIGS. 1, 2, 6 or 11A).

As shown, a system 1365 is provided including at least one central processing unit 1330 that is connected to a communication bus 1375. The communication bus 1375 may be implemented using any suitable protocol, such as PCI (Peripheral Component Interconnect), PCI-Express, AGP (Accelerated Graphics Port), HyperTransport, or any other bus or point-to-point communication protocol(s). The system 1365 also includes a main memory 1340. Control logic (software) and data are stored in the main memory 1340 which may take the form of random access memory (RAM).

The system 1365 also includes input devices 1360, the parallel processing system 1325, and display devices 1345, e.g. a conventional CRT (cathode ray tube), LCD (liquid crystal display), LED (light emitting diode), plasma display or the like. User input may be received from the input devices 1360, e.g., keyboard, mouse, touchpad, microphone, and the like. Each of the foregoing modules and/or devices may even be situated on a single semiconductor platform to form the system 1365. Alternately, the various modules may also be situated separately or in various combinations of semiconductor platforms per the desires of the user.

Further, the system 1365 may be coupled to a network (e.g., a telecommunications network, local area network (LAN), wireless network, wide area network (WAN) such as the Internet, peer-to-peer network, cable network, or the like) through a network interface 1335 for communication purposes.

The system 1365 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1340 and/or the secondary storage. Such computer programs, when executed, enable the system 1365 to perform various functions. The memory 1340, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1365 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

An application program may be implemented via an application executed by a host processor, such as a CPU. In an embodiment, a device driver may implement an application programming interface (API) that defines various functions that can be utilized by the application program in order to generate graphical data for display. The device driver is a software program that includes a plurality of instructions that control the operation of the PPU 1000. The API provides an abstraction for a programmer that lets a programmer utilize specialized graphics hardware, such as the PPU 1000, to generate the graphical data without requiring the programmer to utilize the specific instruction set for the PPU 1000. The application may include an API call that is routed to the device driver for the PPU 1000. The device driver interprets the API call and performs various operations to respond to the API call. In some instances, the device driver may perform operations by executing instructions on the CPU. In other instances, the device driver may perform operations, at least in part, by launching operations on the PPU 1000 utilizing an input/output interface between the CPU and the PPU 1000. In an embodiment, the device driver is configured to implement the graphics processing pipeline 1400 utilizing the hardware of the PPU 1000.

Various programs may be executed within the PPU 1000 in order to implement the various stages of the processing for the application program. For example, the device driver may launch a kernel on the PPU 1000 to perform one stage of processing on one SM 1140 (or multiple SMs 1140). The device driver (or the initial kernel executed by the PPU 1000) may also launch other kernels on the PPU 1000 to perform other stages of the processing. If the application program processing includes a graphics processing pipeline, then some of the stages of the graphics processing pipeline may be implemented on fixed unit hardware such as a rasterizer or a data assembler implemented within the PPU 1000. It will be appreciated that results from one kernel may be processed by one or more intervening fixed function hardware units before being processed by a subsequent kernel on an SM 1140.

All patents, patent applications and publications cited herein are incorporated by reference for all purposes as if expressly set forth.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of synchronizing an exchange of data between a producer on a first processor and a consumer on a second processor, comprising:
receiving, at the second processor, a first data message from the producer, the first data message identifying the data;
in response to the first data message, storing the data in a memory buffer associated with the second processor;
updating a barrier memory structure in a memory associated with the second processor, wherein an elapsed time from the storing to the updating is less than a one-way time from the producer to the second processor; and
in response to the updating, providing for the data in the memory buffer to be read by the consumer.

2. The method according to claim 1, wherein the consumer and the producer are in respective cooperative thread arrays (CTA) in a same cooperative grid array (CGA), and wherein the memory buffer and the barrier memory structure are in a shared memory associated with the second processor.

3. The method according to claim 1, wherein a time elapsed from a sending of the first data message by the producer to receiving notification of availability of the data in the memory buffer by the consumer is less than a latency of a roundtrip from the producer to the memory buffer.

4. The method according to claim 1, further comprises:
receiving a second data message from a second producer, the second data message including a second data; and
in response to the second data message, storing the second data in the memory buffer and updating the barrier memory structure,
wherein said providing for the data in the memory buffer to be read by the consumer is performed in response to the updating in response to the first data message and the updating in response to the second data message.

5. The method according to claim 4, wherein performing the providing for the data in the memory buffer to be read by the consumer if a clear condition of the barrier memory structure is satisfied.

6. The method according to claim 1, wherein performing the providing for the data in the memory buffer to be read by the consumer if a clear condition of the barrier memory structure is satisfied.

7. The method according to claim 1, wherein the memory barrier structure comprises a first memory barrier structure co-located with the consumer and a second memory barrier structure co-located with the producer, wherein, after the sending of the first data message to the consumer, the producer waits on the second barrier structure, and, after reading the data in the memory buffer, the consumer arrives at the second barrier memory structure.

8. The method according to claim 1, wherein the first data message represents, in a single message, a write of the data to the memory buffer and an update to the memory barrier structure.

9. The method according to claim 1, wherein the first data message includes a combined store and arrive instruction comprising an address of the memory buffer, an address of the barrier memory structure, and the data.

10. The method according to claim 9, wherein the barrier memory structure comprises an arrive count and a transaction count, wherein, in response to the first data message, the arrive count and the transaction count are updated and the transaction count is updated in accordance with an amount of data associated with the first data message.

11. The method according to claim 1, atomically performing the storing the data in the memory buffer and the updating the barrier memory structure.

12. The method according to claim 1, wherein the updating of the barrier memory structure is performed in response to receiving one or more second data messages from the first processor.

13. The method according to claim 12, wherein the one or more second data messages comprise a respective second data message for each path configured in an interconnect switch from the first processor to the second processor.

14. The method according to claim 13,
wherein the barrier memory structure includes an expected arrive count, an actual arrive count, and a fence transaction count,
wherein the first data message is transmitted before the second data message by the first processor, and
wherein the actual arrive count is updated in response to receiving each first data message, and the fence transaction count is updated in response to receiving each second data message.

15. The method according to claim 14, wherein the consumer waits on the barrier memory structure and wherein the barrier memory structure is cleared when the actual arrive count equals the expected arrive count and the fence transaction count represents all said data is written to the data buffer.

16. The method according to claim 1, wherein a buffer queue is configured in an external memory associated with the producer, wherein the second processor pushes receive buffer information to the buffer queue and the producer pops the destination buffer information from the buffer queue, wherein the first processor transmits the data to the receive buffer through the external memory and the second processor writes the data to a memory of the second processor.

17. The method according to claim 16, wherein an agent is initiated in response to a message from the producer, and the agent coordinates exchange of the data from an output queue in a memory of the first processor to an input queue in a local memory of the second processor in coordination with respective direct memory access components in the first processor and the second processor.

18. The method according to claim 1, wherein the first processor and the second processor are respective processors in a non-uniform memory access (NUMA)-organized system.

19. A multiprocessor system comprising at least a first processor and a second processor, the first processor comprising a first memory and the second processor comprising a second memory, and an interconnect connecting the first processor and the second processor,
wherein the second processor is configured to:
receive a first data message;
in response to the first data message, store a data included in the first data message in a memory buffer and update a barrier memory structure, wherein an elapsed time from the storing to the updating is less than a one-way time from a producer on the first processor to the second processor; and
in response to the updating, provide for the data in the memory buffer to be read by a consumer on the second processor,
wherein the first processor is configured to:
transmit, from the producer, the first data message to the consumer.

20. The multiprocessor system according to claim 19, wherein the second processor is further configured to atomically perform said store a data included in the first data message in a memory buffer and said update a barrier memory structure.

21. The multiprocessor system according to claim 19, wherein each of the first processor and the second processor are streaming multiprocessors.

22. The multiprocessor system according to claim 19, wherein the memory buffer and the barrier memory structure are in the second memory.

23. The multiprocessor system according to claim 19, wherein the first data message includes a combined store and arrive instruction comprising an address of the memory buffer, an address of the barrier memory structure and the data.

24. The multiprocessor system according to claim 19, wherein the updating of the barrier memory structure is performed in response to receiving one or more second data messages from the first processor.

25. The multiprocessor system according to claim 24, wherein the one or more second data messages comprise a respective second data message for each predetermined path configured in the interconnect.

26. A method of synchronizing an exchange of data between a producer and a consumer, comprising:
receiving a first data message from the producer;
in response to the first data message, storing the data in a memory buffer and updating a barrier memory structure, wherein the first data message represents, in a single message, a write of the data to the memory buffer and an update to the memory barrier structure; and
in response to the updating, providing for the data in the memory buffer to be read by the consumer.

27. A method of transferring data between first and second processors, comprising:
a first processor writing data into a memory local to a second processor;
the first processor writing a completion flag into the memory local to the second processor; and
the second processor conditioning access to the data written into its local memory on the first processor writing the completion flag;
wherein precautions prevent opportunistic execution reordering from defeating the conditioned access.
